(19) United States
(12) Patent Application Publication
(10) Pub. No.: US 2026/0188891 A1
(43) Pub. Date: Jul. 2, 2026

(54) ELECTRONIC DEVICE

(71) Applicant: Huawei Technologies Co., Ltd., Shenzhen (CN)

(72) Inventors: Ben Lai, Wuhan (CN); Jun You, Wuhan (CN)

(21) Appl. No.: 19/548,324

(22) Filed: Feb. 24, 2026

Related U.S. Application Data
(63) Continuation of application No. PCT/CN2024/127371, filed on Oct. 25, 2024.

(30) Foreign Application Priority Data
Oct. 31, 2023 (CN) 202311441372.3

(51) Int. Cl. H01Q 1/24; H01Q 9/04

(52) U.S. Cl. CPC H01Q 1/243; H01Q 9/0457

(57) ABSTRACT

An electronic device, including an antenna, where the antenna uses a conductive part of a side frame of the electronic device as a first radiator, and a second radiator is spaced from a side of the first radiator. The first radiator and the second radiator disposed close to each other thereby form an antenna structure. The first radiator and the second radiator are configured to generate a composite antenna mode, with relatively low directivity factors.

### CROSS-REFERENCE TO RELATED APPLICATIONS

This application is a continuation of International Application No. PCT/CN2024/127371, filed on Oct. 25, 2024, which claims priority to Chinese Patent Application No. 202311441372.3, filed on Oct. 31, 2023. The disclosures of the aforementioned applications are hereby incorporated by reference in their entireties.

### TECHNICAL FIELD

This application relates to the wireless communication field, and in particular, to an electronic device.

### BACKGROUND

As people have an increasing requirement for high-speed data transmission, a development trend of an industrial design (ID) of an electronic device is to have a large screen-to-body ratio and a plurality of cameras. As a result, layout space of antennas is increasingly limited.

In a current state, in some use scenarios of the electronic device (for example, when the electronic device performs communication via Wi-Fi), in a conventional design, a directivity factor of an antenna is relatively high, causing non-uniform coverage of the antenna and poor communication experience in an area of poor coverage. Therefore, how to design an antenna with a low directivity factor is an urgent problem to be resolved.

### SUMMARY

This application provides an electronic device, including an antenna. The antenna uses a conductive part of a side frame of the electronic device as a first radiator. A second radiator is spaced from a side of the first radiator.

According to a first aspect, an electronic device is provided, including a ground plane; a side frame, where at least a part of the side frame is spaced from the ground plane, the side frame includes a first location and a second location, and the side frame is coupled to the ground plane at the first location and the second location; and an antenna. The antenna includes: a first radiator, where the first radiator includes a conductive part of the side frame between the first location and the second location; and a second radiator, where the second radiator is spaced from the first radiator and the ground plane, a projection of the second radiator on the side frame in a first direction at least partially overlaps the first radiator, and the first direction is a direction perpendicular to an extension direction of the first radiator. The first radiator and the second radiator are configured to generate a first resonance. A distance D1 between the first radiator and the second radiator is less than or equal to 10 mm or a quarter of a first wavelength. The first wavelength is a wavelength corresponding to the first resonance. A ratio of a size L2 of the second radiator in a second direction X to a size L3 of the second radiator in the first direction Y is greater than 1. The second direction is the extension direction of the first radiator. A first end of the second radiator is an open end, and a second end of the second radiator is a ground end. A distance between the first end of the second radiator and the first radiator is less than a distance between the second end of the second radiator and the first radiator.

According to this embodiment of this application, a new antenna structure is formed by using the first radiator and the second radiator that are disposed close to each other (for example, the distance D1 is less than or equal to 10 mm or a quarter of the first wavelength). The first radiator and the second radiator are configured to generate a composite antenna mode (generated by the first radiator and the second radiator together, and not generated by a single radiator), and have relatively low directivity factors, so that the electronic device has good communication performance in all directions.

It should be understood that a higher directivity factor indicates a larger proportion of energy radiated by the antenna in a direction, and more concentrated energy radiation. When the directivity factor of the antenna is relatively high, energy radiated by the antenna in a maximum radiation direction accounts for a relatively high proportion. In this case, energy radiated by the antenna in other directions accounts for a relatively low proportion. When a user uses an electronic device including the antenna, the electronic device can have good communication performance only in a neighboring area in the maximum radiation direction of the antenna. When the electronic device carried by the user moves, and a device (for example, a router) that transmits a signal with the antenna is not in a neighboring area in the maximum radiation direction of the antenna, communication performance of the electronic device deteriorates, which affects user experience.

With reference to the first aspect, in some implementations of the first aspect, at the resonance point of the first resonance, a direction of an electric field between the first radiator and the second radiator is opposite to that of an electric field between the first radiator and the ground plane.

With reference to the first aspect, in some implementations of the first aspect, at the resonance point of the first resonance, a magnetic field between the first radiator and the second radiator and a magnetic field between the first radiator and the ground plane are parallel to the ground plane. With reference to the first aspect, in some implementations of the first aspect, at the resonance point of the first resonance, a null of a directivity pattern generated by the antenna is not located in a circumferential direction of the electronic device.

According to this embodiment of this application, at the resonance point of the first resonance, the direction of the electric field between the first radiator and the second radiator is opposite to that of the electric field between the first radiator and the ground plane. The electric field between the first radiator and the second radiator is directed from the first radiator to the second radiator. For example, the electric field is in a negative direction of a y-axis. The electric field between the first radiator and the ground plane is directed from the ground plane to the first radiator. For example, the electric field is in a positive direction of the y-axis.

However, because both the electric field between the first radiator and the second radiator and the electric field between the first radiator and the ground plane may generate magnetic fields parallel to the ground plane (for example, parallel to an x-y plane), for example, directions of the magnetic fields are the same in a positive direction of a z-axis, a radiation characteristic of the antenna in a direction parallel to the ground plane (for example, parallel to the x-y plane) is improved.

In an embodiment, because the magnetic fields parallel to the ground plane (for example, parallel to the x-y plane) may be generated, the null of the directivity pattern is not located in a circumferential direction of the electronic device, thereby improving the radiation characteristic of the antenna in the direction parallel to the ground plane (for example, parallel to the x-y plane). The null of the directivity pattern may be understood as a minimum amplitude of the directivity pattern.

With reference to the first aspect, in some implementations of the first aspect, a length L1 of the first radiator and the size L2 of the second radiator in the second direction satisfy: L1×50%≤L2≤L1×200%.

According to this embodiment of this application, when the length L1 of the first radiator and the size L2 of the second radiator in the second direction are within the foregoing range, this helps generate the composite mode of the first radiator and the second radiator, thereby improving a radiation characteristic of the antenna at the first resonance.

With reference to the first aspect, in some implementations of the first aspect, a ratio of the size L2 of the second radiator in the second direction X to the size L3 of the second radiator in the first direction Y is less than or equal to 3.

According to this embodiment of this application, the size L2 of the second radiator in the second direction (for example, an x direction) increases, to improve radiation efficiency and system efficiency of the antenna.

In addition, the first radiator may be in a structure similar to a slot antenna, and the second radiator may be in a structure similar to a PIFA. This helps generate the composite mode of the first radiator and the second radiator.

With reference to the first aspect, in some implementations of the first aspect, a resonance point frequency of the first resonance is greater than or equal to 0.7 GHZ and less than or equal to 6 GHz.

According to this embodiment of this application, an operating frequency band of the antenna may include a 5G frequency band of Wi-Fi.

With reference to the first aspect, in some implementations of the first aspect, the size of the second radiator in the first direction is greater than or equal to 2 mm and less than or equal to 25 mm.

With reference to the first aspect, in some implementations of the first aspect, the size of the second radiator in the first direction is greater than or equal to one twenty-fifth of the first wavelength and less than or equal to a half of the first wavelength.

According to this embodiment of this application, the size of the second radiator in the first direction may be used to adjust coupling between the first radiator and the second radiator, to adjust the resonance point frequency of the first resonance generated in the composite mode.

With reference to the first aspect, in some implementations of the first aspect, the antenna further includes an electronic element, where the electronic element is in coupling connection between the first radiator and the second radiator.

According to this embodiment of this application, the electronic element may be configured to adjust coupling between the first radiator and the second radiator, to adjust the resonance point frequency of the first resonance generated in the composite mode.

With reference to the first aspect, in some implementations of the first aspect, a ratio of a length of an overlapping part between the first radiator and the projection of the second radiator on the side frame in the first direction, to the length of the first radiator is greater than or equal to 30%.

According to this embodiment of this application, when the ratio is greater than or equal to 30%, a relatively good coupling characteristic may be implemented between the first radiator and the second radiator, and the antenna has a better radiation characteristic. When the first radiator and the second radiator fully overlap in the first direction, the coupling characteristic between the first radiator and the second radiator is optimal.

With reference to the first aspect, in some implementations of the first aspect, the second radiator is sheet-shaped. In the first direction, the first end of the second radiator is a first side close to the first radiator, and the second end of the second radiator is a second side away from the first radiator. The first side is suspended; and at least a part of the second side is in coupling connection to the ground plane.

According to this embodiment of this application, an edge of the second radiator may be a straight line, a curve, or a broken line. This is not limited in this embodiment of this application. For brevity of description, description is provided by merely using an example in which the edge is a straight line.

With reference to the first aspect, in some implementations of the first aspect, the antenna further includes a feed circuit. One of the first radiator and the second radiator includes a feed point. The feed circuit is coupled to the feed point.

With reference to the first aspect, in some implementations of the first aspect, the antenna further includes a feed circuit and a feed stub. The feed stub is spaced from the first radiator, the second radiator, and the ground plane. The feed stub includes a feed point. The feed circuit is coupled to the feed point.

According to this embodiment of this application, a feed form of the antenna is not limited, and may be determined based on an actual layout in the electronic device. For example, the feed point may be located on the first radiator, the second radiator, or the separately disposed feed stub.

With reference to the first aspect, in some implementations of the first aspect, the first radiator and the second radiator are further configured to generate a second resonance. A resonance frequency of the second resonance is lower than a resonance frequency of the first resonance. A resonance frequency band of the first resonance includes a first frequency band. A resonance frequency band of the second resonance includes a second frequency band.

According to this embodiment of this application, the new antenna structure formed by the first radiator and the second radiator that are disposed close to each other may have a plurality of composite modes, to generate a plurality of resonances, thereby expanding bandwidth of the antenna.

With reference to the first aspect, in some implementations of the first aspect, the first frequency band includes a 5G frequency band of Wi-Fi, and the second frequency band includes a 2.4G frequency band of Wi-Fi.

With reference to the first aspect, in some implementations of the first aspect, the antenna further includes a parasitic stub. The feed stub is located between the parasitic stub and the second radiator. A first end of the parasitic stub is a ground end, and a second end of the parasitic stub is an open end. A ratio of a size of the parasitic stub in the first direction to a size of the parasitic stub in the second direction is greater than 1.

According to this embodiment of this application, a parasitic resonance may be generated by using the sheet-shaped parasitic stub, to expand operating bandwidth of the antenna.

With reference to the first aspect, in some implementations of the first aspect, the parasitic stub is configured to generate a parasitic resonance. A resonance frequency of the parasitic resonance is lower than a resonance frequency of the first resonance. A resonance frequency band of the first resonance includes a first frequency band. A resonance frequency band of the parasitic resonance includes a third frequency band.

According to this embodiment of this application, when the feed circuit feeds an electrical signal, the parasitic stub may generate a parasitic resonance. The resonance frequency band of the parasitic resonance may include a third frequency band. Efficiency (for example, radiation efficiency and system efficiency) of the parasitic resonance generated by the parasitic stub is higher than efficiency at the second resonance generated by the first radiator and the second radiator. Compared with the second resonance, the radiation characteristic of the antenna on the frequency band can be improved by using the resonance frequency band of the parasitic resonance as a communication frequency band.

With reference to the first aspect, in some implementations of the first aspect, the resonance frequency band of the first resonance includes a first frequency band. The first frequency band includes a 5G frequency band of Wi-Fi, and the third frequency band includes a 2.4G frequency band of Wi-Fi.

### BRIEF DESCRIPTION OF THE DRAWINGS

FIG. 1 is a diagram of an electronic device 10 according to an embodiment of this application;

FIG. 2 is a diagram of an electronic device 10 according to an embodiment of this application;

FIG. 3 shows a simulation result of a directivity factor of an antenna 200 in the electronic device 10 shown in FIG. 2;

FIG. 4 is a diagram of an electronic device 10 according to an embodiment of this application;

FIG. 5 is a cross-sectional diagram of the electronic device 10 shown in FIG. 4 along A-A′;

FIG. 6 shows an S-parameter simulation result of an antenna 200 shown in FIG. 4;

FIG. 7 shows simulation results of radiation efficiency and system efficiency of an antenna 200 shown in FIG. 4;

FIG. 8 is a directivity pattern of an antenna 200 shown in FIG. 4 at a resonance point (for example, 5.2 GHz) of a first resonance;

FIG. 9 is a diagram of electric field distribution of an antenna 200 shown in FIG. 4 at a resonance point (for example, 5.2 GHz) of a first resonance;

FIG. 10 is a diagram of another electronic device 10 according to an embodiment of this application;

FIG. 11 shows an S-parameter simulation result of an antenna 200 shown in FIG. 10;

FIG. 12 shows simulation results of radiation efficiency and system efficiency of an antenna 200 shown in FIG. 10;

FIG. 13 is a directivity pattern of an antenna 200 shown in FIG. 10 at a resonance point (for example, 5.2 GHZ) of a first resonance;

FIG. 14 is a diagram of another electronic device 10 according to an embodiment of this application;

FIG. 15 shows an S-parameter simulation result of an antenna 200 shown in FIG. 14;

FIG. 16 shows simulation results of radiation efficiency and system efficiency of an antenna 200 shown in FIG. 14;

FIG. 17 is a directivity pattern of an antenna 200 shown in FIG. 14 at a resonance point (for example, 5.2 GHz) of a first resonance;

FIG. 18 shows an S-parameter simulation result of an antenna 200 shown in FIG. 14;

FIG. 19 shows simulation results of radiation efficiency and system efficiency of an antenna 200 shown in FIG. 14;

FIG. 20 is a directivity pattern of an antenna 200 shown in FIG. 14 at a resonance point (for example, 5.2 GHz) of a first resonance;

FIG. 21 is a diagram of another electronic device 10 according to an embodiment of this application;

FIG. 22 shows an S-parameter simulation result of an antenna 200 shown in FIG. 21;

FIG. 23 shows simulation results of radiation efficiency and system efficiency of an antenna 200 shown in FIG. 21;

FIG. 24 is a directivity pattern of an antenna 200 shown in FIG. 21 at a resonance point (for example, 5.2 GHZ) of a first resonance;

FIG. 25 is a diagram of another electronic device 10 according to an embodiment of this application;

FIG. 26 shows an S-parameter simulation result of an antenna 200 shown in FIG. 25;

FIG. 27 shows simulation results of radiation efficiency and system efficiency of an antenna 200 shown in FIG. 25;

FIG. 28 is a directivity pattern of an antenna 200 shown in FIG. 25 at a resonance point (for example, 2.4 GHz) of a parasitic resonance;

FIG. 29 is a directivity pattern of an antenna 200 shown in FIG. 25 at a resonance point (for example, 5.2 GHz) of a first resonance;

FIG. 30 is a diagram of another electronic device 10 according to an embodiment of this application;

FIG. 31 shows an S-parameter simulation result of an antenna 200 shown in FIG. 30;

FIG. 32 shows simulation results of radiation efficiency and system efficiency of an antenna 200 shown in FIG. 30;

FIG. 33 is a directivity pattern of an antenna 200 shown in FIG. 30 at 5.2 GHz;

FIG. 34 is a directivity pattern of an antenna 200 shown in FIG. 30 at 5.8 GHz; and

FIG. 35 is a diagram of an electronic device 10 according to an embodiment of this application.

### DETAILED DESCRIPTION OF ILLUSTRATIVE EMBODIMENTS

The following describes technical solutions of this application with reference to accompanying drawings.

It should be understood that the term “and/or” in this specification describes only a same field for describing associated objects and indicates that three relationships may exist. For example, A and/or B may indicate the following three cases: Only A exists, both A and B exist, and only B exists. In addition, the character “/” in this specification generally indicates an “or” relationship between the associated objects.

In this application, “within a range of . . . ” is used, except when it is separately specified that no end value is included, end values at both ends of the range are included by default. For example, within a range from 1 to 5, two values 1 and 5 are included.

Coupling: The coupling may be understood as direct coupling and/or indirect coupling, and a “coupling connection” may be understood as a direct coupling connection and/or an indirect coupling connection. The direct coupling may also be referred to as an “electrical connection”, which may be understood as physical contact and electrical conduction of components, or may be understood as a form of connection between different components in a line structure through a physical line that can transmit an electrical signal, for example, a printed circuit board (PCB) copper foil or a conducting wire. The “indirect coupling” may be understood as electrical conduction of two conductors in a spaced/non-contact manner. In an embodiment, the indirect coupling may also be referred to as capacitive coupling. For example, signal transmission is implemented by forming an equivalent capacitor through coupling in a gap between two spaced conductive members.

Element/Component: The element/component includes at least one of a lumped element/component, and a distributed element/component.

Lumped element/component: The lumped element/component is a general name of all elements whose dimensions are far less than a wavelength corresponding to an operating frequency of a circuit. For a signal, a characteristic of the element is constant at any time, regardless of a frequency.

Distributed element/component: A difference between the distributed element and a lumped element lies in that if dimensions of an element are close to or greater than a wavelength corresponding to an operating frequency of a circuit, a characteristic of each point of the element varies with a signal when the signal passes through the element. In this case, the element cannot be considered as a single entity with a constant characteristic, but needs to be referred to as a distributed element.

Capacitor: The capacitor may be understood as a lumped capacitor and/or a distributed capacitor. The lumped capacitor is a capacitive component, for example, a capacitive element. The distributed capacitor (or a distributed type capacitor) is an equivalent capacitor formed by two conductive members that are spaced apart by a specific slot.

Inductor: The inductor may be understood as a lumped inductor and/or a distributed inductor. The lumped inductor is an inductive component, for example, an inductive element. The distributed inductor (or the distributed type inductor) is an equivalent inductor formed by a conductive member with a specific length.

Radiator: The radiator is an apparatus configured to receive/send electromagnetic wave radiation in an antenna. In some cases, an “antenna” is understood as a radiator in a narrow sense. The antenna converts guided wave energy from a transmitter into a radio wave, or converts a radio wave into guided wave energy to radiate and receive a radio wave. Modulated high-frequency current energy (or guided wave energy) generated by the transmitter is transmitted to a transmit radiator through a feeder. The radiator converts the energy into specific polarized electromagnetic wave energy and radiates the energy in a required direction. A receive radiator converts specific polarized electromagnetic wave energy from a specific direction of space into modulated high-frequency current energy, and transmits the modulated high-frequency current energy to an input end of a receiver through a feeder.

The radiator may include a conductor with a specific shape and dimensions, for example, a linear radiator or a sheet-shaped radiator. A specific shape is not limited in this application. In an embodiment, the linear radiator may be referred to as a wire antenna for short. In an embodiment, the linear radiator may be implemented by a conductive side frame, and may also be referred to as a side frame antenna. In an embodiment, the linear radiator may be implemented by a bracketed conductor, and may also be referred to as a bracketed antenna. In an embodiment, a wire diameter (for example, including a thickness and a width) of the linear radiator or a radiator of the wire antenna is far less than a wavelength (for example, a dielectric wavelength) (for example, is less than 1/16 of the wavelength), and a length may be compared with the wavelength (for example, the dielectric wavelength) (for example, the length is approximately ⅛ of the wavelength, or ⅛ to ¼ of the wavelength, or ¼ to ½ of the wavelength, or greater). Main forms of the wire antenna include the following: a dipole antenna, a half-wave dipole antenna, a monopole antenna, a loop antenna, and an inverted-F antenna (also referred to as an IFA). For example, for the dipole antenna, each dipole antenna usually includes two radiation stubs, and each stub is fed by a feed part from a feed end of the radiation stub. For example, the inverted-F antenna (IFA) may be considered as being obtained by adding a ground path to a monopole antenna. The IFA antenna has a feed point and a ground point, and is referred to as the inverted-F antenna because a side view of the IFA is in an inverted-F shape. In an embodiment, a sheet-shaped radiator may include a microstrip antenna, or a patch antenna, for example, a planar inverted-F antenna (also referred to as PIFA). In an embodiment, the sheet-shaped radiator may be implemented by a planar conductor (for example, a conductive sheet or a conductive coating). In an embodiment, the sheet-shaped radiator may include a conductive sheet, for example, a copper sheet. In an embodiment, the sheet-shaped radiator may include a conductive coating, for example, silver paste. A shape of the sheet-shaped radiator includes a circular shape, a rectangular shape, a ring shape, and the like. A specific shape is not limited in this application. A structure of the microstrip antenna usually includes a dielectric substrate, a radiator, and a ground plane, where the dielectric substrate is disposed between the radiator and the ground plane.

The radiator may also include a slot or a slit formed on the conductor, for example, a closed or semi-closed slot or slit formed on a grounded conductor surface. In an embodiment, a radiator with a slot or a slit may be referred to as a slot antenna or a slotted antenna for short. In an embodiment, a radial size (for example, including a width) of the slot or the slit of the slot antenna/slotted antenna is far less than a wavelength (for example, a dielectric wavelength) (for example, is less than 1/16 of the wavelength), and a length size may be compared with the wavelength (for example, the dielectric wavelength) (for example, the length is approximately ⅛ of the wavelength, or ⅛ to ¼ of the wavelength, or ¼ to ½ of the wavelength, or greater). In an embodiment, a radiator with a closed slot or slit may be referred to as a closed slot antenna for short. In an embodiment, a radiator with a semi-closed slot or slit (for example, an opening is additionally provided on the closed slot or slit) may be referred to as an open slot antenna for short. In some embodiments, the slot is long strip-shaped. In some embodiments, a length of the slot is approximately half the wavelength (for example, the dielectric wavelength). In some embodiments, a length of the slot is approximately an integer multiple of the wavelength (for example, one dielectric wavelength). In some embodiments, the slot may be used for feeding through a transmission line bridged on one side or two sides of the slot. In this way, a radio frequency electromagnetic field is excited on the slot, and an electromagnetic wave is radiated to space. In an embodiment, a radiator of the slot antenna or the slotted antenna may be implemented by a conductive side frame that is grounded at two ends, and may also be referred to as a side frame antenna. In this embodiment, it may be considered that the slot antenna or the slotted antenna includes a linear radiator, and the linear radiator is spaced apart from the ground plane and is grounded at two ends of the radiator, to form a closed or semi-closed slot or slit. In an embodiment, the radiator of the slot antenna or the slotted antenna may be implemented by a bracketed conductor that is grounded at two ends, and may also be referred to as a bracketed antenna.

A feed circuit is a combination of all circuits for receiving and transmitting radio frequency signals. The feed circuit may include a transceiver and a radio frequency front end (RF front end) circuit. In some cases, in a narrow sense, the “feed circuit” is a radio frequency chip (RFIC, radio frequency integrated circuit), and the RFIC may be considered to include a radio frequency front end chip and the transceiver. The feed circuit has a function of converting a radio wave (for example, a radio frequency signal) and an electrical signal (for example, a digital signal). Usually, the feed circuit is considered as a part of radio frequency.

In some embodiments, an electronic device may further include a test base (which is also referred to as a radio frequency base or a radio frequency test base). A coaxial cable may be inserted into the test base, to test a characteristic of the radio frequency front end circuit or an antenna radiator through the cable. The radio frequency front end circuit may be considered as a circuit part coupled between the test base and the transceiver.

In some embodiments, the radio frequency front end circuit may be integrated into the radio frequency front end chip in the electronic device, or the radio frequency front end circuit and the transceiver may be integrated into the radio frequency chip in the electronic device.

It should be understood that any two of a first feed circuit, a second feed circuit, . . . , and an N^{th} feed circuit in this application may share a same transceiver, for example, transmit a signal through a radio frequency channel in the transceiver (for example, a pin of the radio frequency chip), and may further share a radio frequency front end circuit, for example, process the signal through a switch or an amplifier in a radio frequency front end.

It should be further understood that two of the first feed circuit, the second feed circuit, . . . , and the N^{th} feed circuit in this application usually correspond to two radio frequency test bases in the electronic device.

A matching circuit is a circuit for adjusting a radiation characteristic of the antenna. In an embodiment, the matching circuit is coupled between the feed circuit and a corresponding radiator. In an embodiment, the matching circuit is coupled between a test base and a radiator. Usually, the matching circuit is a combination of circuits coupled between the radiator and the ground plane. In an embodiment, the matching circuit may include a switch and/or an electronic element. The switch may be an electronic element configured to switch a coupling connection of the radiator. The matching circuit has a function of impedance matching and/or frequency tuning. Usually, the matching circuit is considered as a part of the antenna.

Ground structure/feed structure: The ground structure/feed structure may include a connection member, for example, a metal spring plate. The radiator is in coupling connection to the ground plane through the ground structure/in coupling connection to the feed circuit through the feed structure. In some embodiments, the feed structure may include a transmission line/feeder, and the ground structure may include a ground line.

End/Point: The “end/point” in a first end/second end/feed end/ground end/feed point/ground point/connection point of an antenna radiator cannot be understood in a narrow sense as an endpoint or an end part that is necessarily physically disconnected from another radiator, and may also be considered as a point or a segment on a continuous radiator. In an embodiment, the “end/point” may include a connection/coupling area that is on the antenna radiator and that is in coupling connection to another conductive structure. For example, the feed end/feed point may be a coupling area that is on the antenna radiator and that is in coupling connection to a feed structure (for example, an area opposite to a part of the feed structure). For another example, the ground end/ground point may be a connection/coupling area that is on the antenna radiator and that is in coupling connection to the ground structure.

Open end and closed end: In some embodiments, the open end and the closed end are, for example, defined based on whether the end is grounded. The closed end is grounded, and the open end is not grounded. In some embodiments, the open end and the closed end are, for example, defined relative to another conductor. The closed end is electrically connected to the another conductor, and the open end is not electrically connected to the another conductor. In an embodiment, the open end may also be referred to as a floating end, a free end, an opening end, or an open-circuit end. In an embodiment, the closed end may also be referred to as a ground end or a short-circuit end. It should be understood that, in some embodiments, another conductor may be in coupling connection through the open end, to transfer coupling energy (which may be understood as transferring a current).

In some embodiments, the “closed end” may also be understood from a perspective of current distribution. The closed end, the ground end, or the like may be understood as a current strong point on a radiator, or may be understood as an electric field weak point on a radiator. In an embodiment, the closed end is coupled to an electronic component (for example, a capacitor or an inductor), so that a current distribution characteristic of the current strong point/an electric field weak point on the radiator may not be changed. In an embodiment, a slit (for example, a slot filled with an insulation material) at or near the closed end may not change a current distribution characteristic of the current strong point/electric field weak point of the radiator at the slit.

In some embodiments, the “open end” may also be understood from a perspective of current distribution. The open end, the floating end, or the like may be understood as a current weak point on a radiator, or may be understood as an electric field strong point on a radiator. In an embodiment, the open end is coupled to an electronic component (for example, a capacitor or an inductor). Therefore, a current distribution characteristic of the current weak point/electric field strong point on the radiator may not be changed.

It should be understood that a radiator end (similar to a radiator at an opening of the open end or the floating end from a perspective of a radiator structure) in a slot is coupled to an electronic component (for example, a capacitor or an inductor), so that the radiator end is a current strong point/electric field weak point. In this case, it should be understood that the radiator end in the slot is actually a closed end, a ground end, or the like.

A “floating radiator” in embodiments of this application means that the radiator is not directly connected to a feeder/feed stub and/or a ground line/ground stub, but is fed and/or grounded in an indirect coupling manner.

It should be understood that “floating” in the “floating end” and the “floating radiator” does not mean that there is no structure around the radiator to support the radiator. In an embodiment, the floating radiator may be, for example, a radiator provided on an inner surface of an insulation rear cover.

That currents are in a same direction/opposite directions in embodiments of this application should be understood as that directions of main currents on conductors on a same side are the same/opposite. For example, when co-directionally distributed currents are excited on a bent conductor or an annular conductor (for example, a current path is also bent or annular), it should be understood that, for example, although directions of main currents excited on conductors on two sides of the annular conductor (for example, on conductors on two sides of a slot in conductors around the slot) are opposite, the main currents still fall within a definition of co-directionally distributed currents in embodiments of this application. In an embodiment, that currents on a conductor are in a same direction may mean that the currents on the conductor have no reverse point. In an embodiment, that currents on a conductor are in opposite directions may mean that the currents on the conductor have at least one reverse point. In an embodiment, that currents on two conductors are in a same direction may mean that none of the currents on the two conductors has a reverse point and the currents flow in the same direction. In an embodiment, that currents on two conductors are in opposite directions may mean that none of the currents on the two conductors has a reverse point and the currents flow in the opposite directions. It may be correspondingly understood that currents on a plurality of conductors are in a same direction/opposite directions.

That electric fields are in a same direction/opposite directions in embodiments of this application should be understood as that directions of main electric fields (for example, electric fields between the conductor and the ground plane) generated by the conductors in the space are the same/opposite. For example, when co-directionally distributed electric fields are excited on a bent conductor or an annular conductor (for example, a spacing formed between the ground plane and the conductor is also bent or annular), it should be understood that, for example, directions of electric fields in the spacing are from the ground plane to the conductor or from the conductor to the ground plane, and although main electric fields excited in spacings on two sides of the annular conductor (for example, on conductors around a slot, or in spacings on two sides of a slot) are in opposite directions, the main electric fields still meet a definition of co-directionally distributed electric fields in embodiments of this application. In an embodiment, that electric fields between a conductor and the ground plane are in a same direction may mean that the electric fields between the conductor and the ground plane have no reverse point. In an embodiment, that electric fields between a conductor and the ground plane are in opposite directions may mean that the electric fields between the conductor and the ground plane have at least one reverse point. In an embodiment, that electric fields between two conductors and the ground plane are in a same direction may mean that none of the electric fields between the two conductors and the ground plane has a reverse point and the electric fields radiate in a same direction (for example, a positive direction of a z-axis). In an embodiment, that electric fields between two conductors and the ground plane are in opposite directions may mean that none of the electric fields between the two conductors and the ground plane has a reverse point and the electric fields flow in opposite directions. It may be correspondingly understood that electric fields between a plurality of conductors and the ground plane are in a same direction/opposite directions.

Resonance/Resonance frequency: The resonance frequency is also referred to as a resonant frequency. The resonance frequency may have a frequency range, namely, a frequency range in which a resonance occurs. A frequency corresponding to a strongest resonance point is a center frequency. A return loss of the center frequency may be less than −20 dB. It should be understood that, unless otherwise specified, an antenna/a radiator generates a “first/second . . . resonance” in this application, where the first resonance should be a fundamental mode resonance generated by the antenna/radiator, or a resonance that is generated by the antenna/radiator and that has a lowest frequency. It should be understood that the antenna/radiator may generate one or more antenna modes based on a specific design, and one fundamental mode resonance may be correspondingly generated in each antenna mode.

Resonance frequency band: A range of a resonance frequency is the resonance frequency band, and a return loss of any frequency on the resonance frequency band may be less than −6 dB or −5 dB.

Communication frequency band/Operating frequency band: Regardless of a type of antenna, the antenna constantly operates in a specific frequency range (a frequency bandwidth). For example, an operating frequency band of an antenna supporting a B40 frequency band includes a frequency in a range of 2300 MHz to 2400 MHz. In other words, the operating frequency band of the antenna includes the B40 frequency band. A frequency range that meets a requirement of an indicator may be considered as an operating frequency band of an antenna.

The resonance frequency band and the operating frequency band may be the same, or may partially overlap. In an embodiment, one or more resonance frequency bands of an antenna may cover one or more operating frequency bands of the antenna.

Electrical length: The electrical length may be a ratio of a physical length (namely, a mechanical length or a geometric length) to a wavelength of a transmitted electromagnetic wave, and the electrical length may satisfy the following formula:

$$\overline{L} = \frac{L}{λ} .$$

Herein, L is the physical length, and λ is the wavelength of the electromagnetic wave.

Wavelength: The wavelength or an operating wavelength may be a wavelength corresponding to a center frequency of a resonance frequency or a center frequency of an operating frequency band supported by an antenna. For example, it is assumed that a center frequency of a B1 uplink frequency band (with a resonance frequency ranging from 1920 MHz to 1980 MHz) is 1955 MHz. In this case, an operating wavelength may be a wavelength calculated based on the frequency of 1955 MHz. The “operating wavelength” is not limited to the center frequency, and may alternatively be a wavelength corresponding to a non-center frequency of the resonance frequency or the operating frequency band.

It should be understood that a wavelength of a radiated signal in the air may be calculated as follows: (Air wavelength or vacuum wavelength)=speed of light/frequency, where the frequency is a frequency (MHz) of the radiated signal, and the speed of light may be 3×10⁸ m/s. A wavelength of a radiated signal in a dielectric may be calculated as follows: Dielectric wavelength=(speed of light/\sqrt{ε})/frequency, where E is a relative dielectric constant of the dielectric. The wavelength in embodiments of this application is usually a dielectric wavelength, and may be a dielectric wavelength corresponding to a center frequency of a resonance frequency, or a dielectric wavelength corresponding to a center frequency of an operating frequency band supported by an antenna. For example, it is assumed that a center frequency of a B1 uplink frequency band (with a resonance frequency ranging from 1920 MHz to 1980 MHz) is 1955 MHz. In this case, a wavelength may be a dielectric wavelength calculated based on the frequency of 1955 MHz. The “dielectric wavelength” is not limited to the center frequency, and may alternatively be a dielectric wavelength corresponding to a non-center frequency of the resonance frequency or the operating frequency band. For ease of understanding, the dielectric wavelength mentioned in embodiments of this application may be simply calculated based on a relative dielectric constant of a medium filled in one or more sides of a radiator.

A person skilled in the art may understand that efficiency is usually indicated by a percentage, and there is a corresponding conversion relationship between the efficiency and dB. Efficiency closer to 0 dB indicates better efficiency of the antenna.

Antenna pattern: The antenna pattern is also referred to as a radiation pattern, is a pattern in which relative field strength (a normalized modulus value) of a radiation field of an antenna changes with a direction at a specific distance from the antenna (a far field), and is usually represented by two plane patterns that are perpendicular to each other in a maximum radiation direction of the antenna.

The antenna pattern usually includes a plurality of radiation beams. A radiation beam with highest radiation strength is referred to as a main lobe, and another radiation beam is referred to as a minor lobe or side lobe. In minor lobes, a minor lobe in an opposite direction of the main lobe is also referred to as a back lobe.

Directivity factor: The directivity factor is also referred to as directionality of an antenna. The directivity factor is a ratio of a maximum power density to an average value in an antenna pattern at a specific distance from the antenna (a far field), is a dimensionless ratio greater than or equal to 1, and may indicate an energy radiation characteristic of the antenna. A higher directivity factor indicates a larger proportion of energy radiated by the antenna in a direction, and more concentrated energy radiation.

Total efficiency of an antenna: The total efficiency of the antenna is a ratio of input power to output power at an antenna port.

Radiation efficiency of an antenna: The radiation efficiency of the antenna is a ratio of power radiated by the antenna to the space (namely, power that is effectively converted into an electromagnetic wave) to active power input to the antenna. Active power input to the antenna=input power of the antenna-loss power. The loss power mainly includes return loss power and metal ohmic loss power and/or dielectric loss power. The radiation efficiency is a value for measuring a radiation capability of an antenna. Both a metal loss and a dielectric loss are factors that affect the radiation efficiency.

A person skilled in the art may understand that efficiency is usually indicated by a percentage, and there is a corresponding conversion relationship between the efficiency and dB. Efficiency closer to 0 dB indicates better efficiency of the antenna.

Antenna return loss: The antenna return loss may be understood as a ratio of power of a signal reflected back to an antenna port through an antenna circuit to transmit power of the antenna port. A smaller reflected signal indicates a larger signal radiated by the antenna to space and higher radiation efficiency of the antenna. A larger reflected signal indicates a smaller signal radiated by the antenna to space and lower radiation efficiency of the antenna.

The antenna return loss may be represented by an S11 parameter, and S11 is one of S parameters. S11 indicates a reflection coefficient, and the parameter can represent transmit efficiency of the antenna. The S11 parameter is usually a negative number. A smaller S11 parameter indicates a smaller antenna return loss, less energy reflected back by the antenna, namely, more energy that actually enters the antenna, and higher system efficiency of the antenna. A greater S11 parameter indicates a greater antenna return loss and lower system efficiency of the antenna.

It should be noted that, an S11 value of −6 dB is usually used as a standard in engineering. When an S11 value of the antenna is less than −6 dB, it may be considered that the antenna can operate normally, or it may be considered that transmit efficiency of the antenna is high.

Ground (ground plane) (GND): The ground (the ground plane) may generally be at least a part of any ground layer, ground plate, ground metal layer, or the like in an electronic device (for example, a mobile phone), or at least a part of any combination of any ground layer, ground plate, ground component, or the like. The “ground” may be configured to ground a component in the electronic device. In an embodiment, the “ground” may be a ground layer of a circuit board of the electronic device, or may be a ground plate formed by a middle frame of the electronic device or a ground metal layer formed by a metal film below a screen of the electronic device. In an embodiment, the circuit board may be a printed circuit board (PCB), for example, an 8-layer board, a 10-layer board, a 12-layer board, a 13-layer board, or a 14-layer board with 8, 10, 12, 13, or 14 layers of conductive materials, or an element that is separated and electrically insulated by a dielectric layer or an insulation layer, for example, a glass fiber or a polymer. In an embodiment, the circuit board includes a dielectric substrate, a ground layer, and a trace layer. The trace layer and the ground layer are electrically connected through a via. In an embodiment, components such as a display, a touchscreen, an input button, a transmitter, a processor, a memory, a battery, a charging circuit, and a system on a chip (SoC) structure may be mounted on or connected to the circuit board, or electrically connected to the trace layer and/or the ground layer in the circuit board. For example, a radio frequency source is disposed on the trace layer.

Any of the foregoing ground layers, or ground planes, or ground metal layers is made of conductive materials. In an embodiment, the conductive material may be any one of the following materials: copper, aluminum, stainless steel, brass and alloys thereof, copper foil on insulation laminates, aluminum foil on insulation laminates, gold foil on insulation laminates, silver-plated copper, silver-plated copper foil on insulation laminates, silver foil on insulation laminates and tin-plated copper, cloth impregnated with graphite powder, graphite-coated laminates, copper-plated laminates, brass-plated laminates, and aluminum-plated laminates. A person skilled in the art may understand that the ground layer/ground plane/ground metal layer may alternatively be made of other conductive materials.

Grounding: The grounding means coupling with the ground/ground plane in any manner. In an embodiment, grounding may be grounding via an entity, for example, grounding via an entity (or referred to as entity grounding) at a specific location on a side frame is implemented through some mechanical members of a middle frame. In an embodiment, the grounding may be grounding through a component, for example, grounding through a component (or referred to as component grounding) like a capacitor/inductor/resistor connected in series or in parallel.

The following describes technical solutions of embodiments in this application with reference to accompanying drawings.

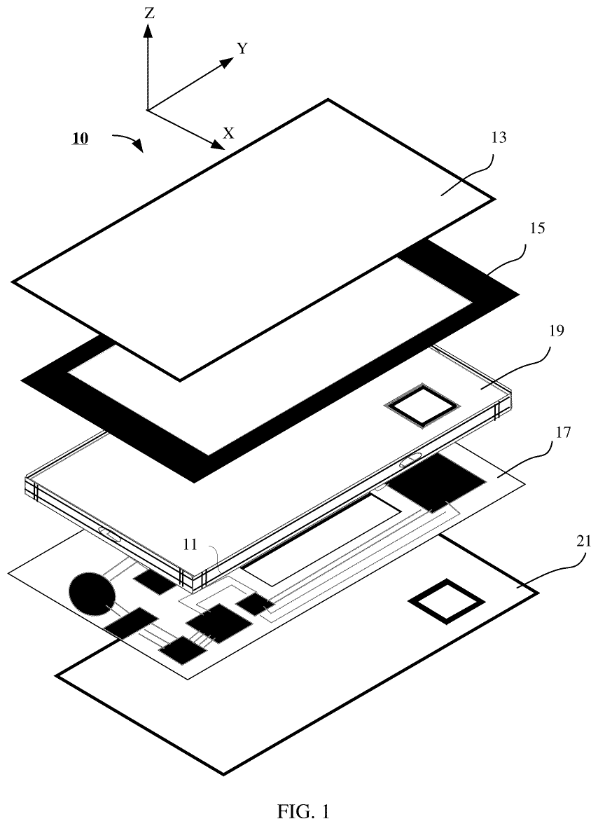

As shown in FIG. 1, an electronic device 10 may include a cover (cover) 13, a display/display module 15, a printed circuit board (PCB) 17, a middle frame 19, and a rear cover 21. It should be understood that, in some embodiments, the cover 13 may be cover glass, or may be replaced with a cover made of another material, for example, a cover made of a PET (polyethylene terephthalate) material.

The cover 13 may be tightly attached to the display module 15, and may be mainly configured to implement protection and dust-resistance functions for the display module 15.

In an embodiment, the display module 15 may include a liquid crystal display (LCD) panel, a light-emitting diode (LED) display panel, an organic light-emitting semiconductor (OLED) display panel, or the like. This is not limited in embodiments of this application.

The middle frame 19 is mainly used to support the entire electronic device. FIG. 1 shows that the PCB 17 is disposed between the middle frame 19 and the rear cover 21. It should be understood that, in an embodiment, the PCB 17 may alternatively be disposed between the middle frame 19 and the display module 15. This is not limited in embodiments of this application. The printed circuit board PCB 17 may be a flame-resistant material (FR-4) dielectric board, or may be a Rogers dielectric board, or may be a hybrid dielectric board of Rogers and FR-4, or the like. Herein, FR-4 is a grade designation of a flame-retardant material, and the Rogers dielectric board is a high-frequency board. An electronic element, for example, a radio frequency chip, is carried on the PCB 17. In an embodiment, a metal layer may be disposed on the printed circuit board PCB 17. The metal layer may be configured to ground the electronic element carried on the printed circuit board PCB 17, or may be configured to ground another element, for example, a bracketed antenna or a side frame antenna. The metal layer may be referred to as a ground plane, a ground plate, or a ground layer. In an embodiment, the metal layer may be formed by etching metal on a surface of any dielectric board in the PCB 17. In an embodiment, the metal layer configured for grounding may be disposed on a side that is of the printed circuit board PCB 17 that is close to the middle frame 19. In an embodiment, an edge of the printed circuit board PCB 17 may be considered as an edge of the ground layer of the PCB 17. In an embodiment, the metal middle frame 19 may also be configured to ground the foregoing element. The electronic device 10 may further have another ground plane/ground plate/ground layer. As described above, details are not described herein again.

Due to internal compactness of the electronic device, a ground plane/ground plate/ground plane (for example, a printed circuit board, a middle frame, a screen metal layer, and a battery may all be considered as a part of the ground plane) is usually disposed in internal space 0 mm to 2 mm away from an inner surface of the side frame. In an embodiment, a dielectric is filled between the side frame and the ground plane. A length and a width of a rectangle enclosed by an inner surface contour of the filled dielectric may be simply considered as a length and a width of the ground plane. Alternatively, a length and a width of a rectangle enclosed by a contour formed by superposing all conductive parts inside the side frame may be considered as a length and a width of the ground plane.

The electronic device 10 may further include a battery (not shown in the figure). The battery may be disposed between the middle frame 19 and the rear cover 21, or may be disposed between the middle frame 19 and the display module 15. This is not limited in embodiments of this application. In some embodiments, the PCB 17 is divided into a mainboard and a subboard. The battery may be disposed between the mainboard and the subboard. The mainboard may be disposed between the middle frame 19 and an upper edge of the battery, and the subboard may be disposed between the middle frame 19 and a lower edge of the battery.

The electronic device 10 may further include a side frame 11. The side frame 11 may be made of a conductive material like metal. The side frame 11 may be disposed between the display module 15 and the rear cover 21, and circumferentially extends around a periphery of the electronic device 10. The side frame 11 may have four sides surrounding the display module 15, to help fasten the display module 15. In an implementation, the side frame 11 made of the conductive material may be directly used as a conductive side frame of the electronic device 10, for example, form an appearance of the metal side frame. This is applicable to a metal industrial design (ID). In an implementation, an outer surface of the side frame 11 may be made of a conductive material, for example, a metal material, to form an appearance of a metal side frame. In these implementations, a conductive part of the side frame 11 may be used as an antenna radiator of the electronic device 10.

In another implementation, an outer surface of the side frame 11 may alternatively be made of a non-conductive material, for example, plastic, to form an appearance of a non-metal side frame. This is applicable to a non-metal ID. In an implementation, an inner surface of the side frame 11 may include a conductive material, for example, a metal material. In this implementation, a conductive part of the side frame 11 may be used as an antenna radiator of the electronic device 10. It should be understood that the radiator disposed on the inner surface of the side frame 11 (namely, a conductive material on the inner surface) is attached to a non-conductive material of the side frame 11, to facilitate antenna radiation. Both the conductive material and the non-conductive material should be considered as a part of the side frame 11.

The middle frame 19 may include the side frame 11. The middle frame 19 including the side frame 11 is used as an integrated part, and may support an electronic component in the entire device. The cover 13 and the rear cover 21 are respectively closed along an upper edge and a lower edge of the side frame, to form a casing or a housing of the electronic device. In an embodiment, the cover 13, the rear cover 21, the side frame 11, and/or the middle frame 19 may be collectively referred to as a casing or a housing of the electronic device 10. It should be understood that the “casing or housing” may mean a part or all of any one of the cover 13, the rear cover 21, the side frame 11, and the middle frame 19, or mean a part or all of any combination of the cover 13, the rear cover 21, the side frame 11, and the middle frame 19.

At least a part of the side frame 11 may serve as an antenna radiator to transmit/receive a radio frequency signal. A slot may exist between the part of the side frame 11 that serves as the radiator and another part of the middle frame 19, to ensure that the antenna radiator has a good radiation environment. In an embodiment, the middle frame 19 may be provided with an aperture at the part of the side frame that serves as the radiator, to facilitate radiation of the antenna.

Alternatively, the side frame 11 may not be considered as a part of the middle frame 19. In an embodiment, the side frame 11 may be connected to and integrally formed with the middle frame 19. In another embodiment, the side frame 11 may include a protrusion member extending inward, to be connected to the middle frame 19, for example, connected through a spring plate or a screw, or connected through welding. The protrusion member of the side frame 11 may be further configured to receive a feed signal, so that at least a part of the side frame 11 is used as an antenna radiator to receive/transmit a radio frequency signal. A slot 42 may exist between the middle frame 30 and the part of the side frame that serves as the radiator, to ensure that the antenna radiator has a good radiation environment, and the antenna has a good signal transmission function.

The rear cover 21 may be a rear cover made of a metal material, or may be a rear cover made of a non-conductive material, for example, may be a non-metal rear cover like a glass rear cover and a plastic rear cover, or may be a rear cover made of both a conductive material and a non-conductive material. In an embodiment, the rear cover 21 including the conductive material may replace the middle frame 19, and serves as an integrated part with the side frame 11, to support an electronic component in the entire device.

In an embodiment, the middle frame 19 and/or a conductive part of the rear cover 21 may serve as a reference ground of the electronic device 10. The side frame 11, the PCB 17, and the like of the electronic device may be electrically connected to the middle frame for grounding.

The antenna of the electronic device 10 may be further disposed in the side frame 11. When the side frame 11 of the electronic device 10 is made of a non-conductive material, the antenna radiator may be located in the electronic device 10 and disposed along the side frame 11. For example, the antenna radiator is disposed close to the side frame 11, to minimize a volume occupied by the antenna radiator, and is closer to the outside of the electronic device 10, to achieve better signal transmission effect. It should be noted that, that the antenna radiator is disposed close to the side frame 11 means that the antenna radiator may be tightly attached to the side frame 11, or may be disposed close to the side frame 11. For example, there may be a specific small slot between the antenna radiator and the side frame 11.

The antenna of the electronic device 10 may be further disposed in the casing, for example, a bracketed antenna or a millimeter wave antenna (not shown in FIG. 1). Clearance of the antenna disposed in the housing may be obtained through a slit/hole in any one of the middle frame, and/or the side frame, and/or the rear cover, and/or the display, or through a non-conductive slot/aperture formed between any several of the middle frame, and/or the side frame, and/or the rear cover, and/or the display. The clearance of the antenna may be provided, to ensure a radiation characteristic of the antenna. It should be understood that the clearance of the antenna may be a non-conductive area including any conductive component in the electronic device 10, and the antenna radiates a signal to external space through the non-conductive area. In an embodiment, a form of the antenna 40 may be an antenna form based on a flexible printed circuit (FPC), an antenna form based on laser-direct-structuring (LDS), or an antenna form such as a microstrip antenna (microstrip disk antenna, MDA). In an embodiment, the antenna may alternatively use a transparent structure embedded into a screen of the electronic device 10, so that the antenna is a transparent antenna element embedded into the screen of the electronic device 10.

FIG. 1 shows only an example of some components included in the electronic device 10. Actual shapes, actual sizes, and actual structures of these components are not limited to those in FIG. 1.

It should be understood that, in embodiments of this application, it may be considered that a surface on which the display of the electronic device is located is a front surface, a surface on which the rear cover is located is a rear surface, and a surface on which the side frame is located is a side surface.

It should be understood that, in embodiments of this application, it is considered that when a user holds the electronic device (the user usually holds the electronic device vertically and faces the screen), an orientation in which the electronic device is located has a top part, a bottom part, a left part, and a right part. It should be understood that, in embodiments of this application, it is considered that when a user holds the electronic device (the user usually holds the electronic device vertically and faces the screen), an orientation in which the electronic device is located has a top part, a bottom part, a left part, and a right part.

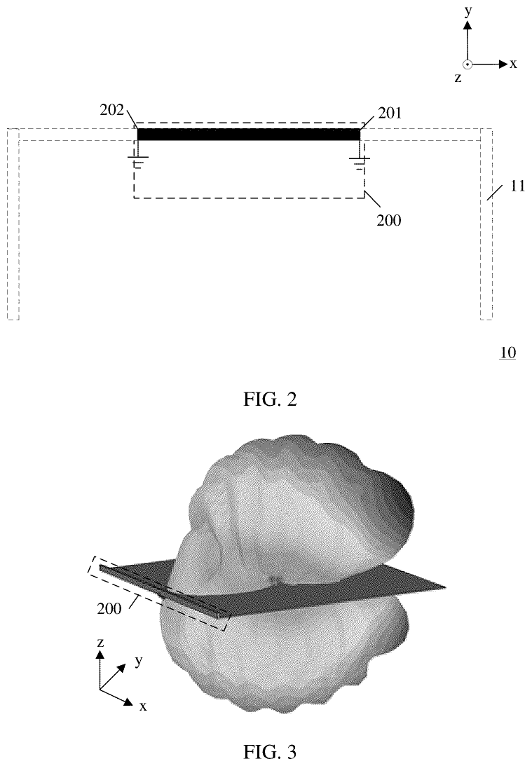

FIG. 2 is a diagram of an electronic device 10 according to an embodiment of this application.

As shown in FIG. 2, the electronic device 10 includes a side frame 11 and an antenna 200.

It should be understood that, for brevity of description, in this embodiment of this application, only a conductive part of a side frame is shown in the accompanying drawing, and a black part of the side frame 11 is used as an antenna radiator in this embodiment of this application.

The side frame 11 includes a first location 201 and a second location 202. The side frame 11 is in coupling connection to the ground plane at the first location 201 and the second location 202.

The antenna 200 includes a radiator and a feed circuit. The radiator is a conductive part between the first location 201 and the second location 202. The radiator includes a feed point. The feed circuit is coupled to the feed point to feed an electrical signal to the antenna 200.

FIG. 3 is a directivity pattern of an antenna 200 in the electronic device 10 shown in FIG. 2.

As shown in FIG. 3, a maximum radiation direction of the antenna 200 is located in a z direction, and a radiation characteristic in a direction parallel to an x-y plane is relatively weak. A directivity factor of the antenna 200 is 8.8 dBi that is relatively high. A communication capability of the electronic device in the direction parallel to the x-y plane is relatively poor, which affects user experience.

A higher directivity factor indicates a larger proportion of energy radiated by the antenna in a direction, and more concentrated energy radiation. When the directivity factor of the antenna is relatively high, energy radiated by the antenna in a maximum radiation direction accounts for a relatively high proportion. In this case, energy radiated by the antenna in other directions accounts for a relatively low proportion. When a user uses an electronic device including the antenna, the electronic device has good communication performance in a neighboring area in the maximum radiation direction of the antenna. When the electronic device carried by the user moves, and a device (for example, a router) that transmits a signal with the antenna is not in a neighboring area in the maximum radiation direction of the antenna, communication performance of the electronic device deteriorates, which affects user experience.

This application provides an electronic device, including an antenna. The antenna includes a part of a side frame of the electronic device as a first radiator and a second radiator that is disposed close to the first radiator. The antenna may have a low directivity factor characteristic by using the first radiator and the second radiator, so that the electronic device has better communication performance.

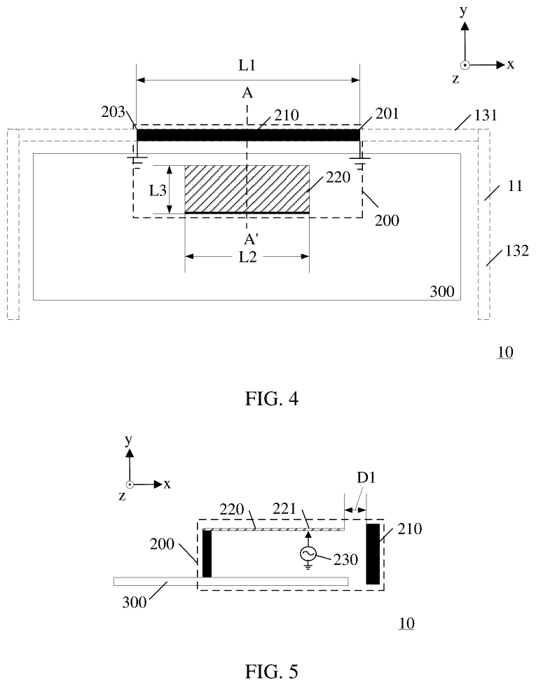

FIG. 4 is a diagram of an electronic device 10 according to an embodiment of this application.

As shown in FIG. 4, the electronic device 10 includes a side frame 11, an antenna 200, and a ground plane 300.

At least a part of the side frame 11 is spaced from the ground plane 300. The side frame 11 includes a first location 201 and a second location 202. The side frame 11 is coupled to the ground plane 300 at the first location 201 and the second location 202.

For brevity of description, direct coupling (electrical connection) is used as an example for description of a coupling connection in embodiments of this application. In actual production or design, the coupling connection may also be implemented in an indirect coupling manner.

In an embodiment, the first location 201 and the second location 202 are coupled to the ground plane 300 to implement grounding of a radiator. The first location 201 and the second location 202 may be electrically connected to the ground plane 300 through a spring plate, or may be electrically connected to the ground plane 300 through an inductor, or may be electrically connected to the ground plane 300 through a ribbon structure. The electrical connection to the ground plane 300 through the ribbon structure may be understood as that at least a part of the side frame 11 and the ground plane 300 are an integrated structure.

In an embodiment, the electronic device includes the middle frame, and the middle frame includes the side frame 11 and the middle plate. In an embodiment, the middle plate is electrically connected to the ground plane 300 at a plurality of locations. In an embodiment, the middle plate may be considered as a part of the ground plane 300. In an embodiment, the side frame 11 is electrically connected to the middle plate through a ribbon structure (not shown in the figure). The ribbon structure (not shown in the figure) is connected between the side frame and the middle plate, and is integrated with the side frame and the middle plate.

The antenna 200 includes a first radiator 210 and a second radiator 220.

The first radiator 210 includes a conductive part of the side frame 11 between the first location 201 and the second location 202. The second radiator 220 is spaced from the first radiator 210 and the ground plane 300. The second radiator 220 and the first radiator 210 at least partially overlap along a first direction (a projection of the second radiator 220 on the side frame 11 in the first direction at least partially overlaps the first radiator 210). The first direction is a direction (for example, a y direction) perpendicular to an extension direction of the first radiator 210.

It should be understood that the extension direction of the first radiator 210 may be understood as an extension direction of the side frame on which the first location 201 or the second location 202 is located. For example, both the first location 201 and the second location 202 are located on a first side of the side frame, and the extension direction of the first radiator 210 is an extension direction (for example, an x direction) of the first side. Alternatively, the first location 201 and the second location 202 are respectively on a first side and a second side that intersect at an angle on the side frame. The extension direction of the first radiator 210 includes an extension direction (for example, an x direction) of the first side and an extension direction (for example, a y direction) of the second side. The second radiator 220 and the first radiator 210 at least partially overlap in a direction perpendicular to any direction in the extension direction of the first radiator 210.

In addition, the second radiator 220 being spaced from the first radiator 210 and the ground plane 300 may be understood as that the second radiator 220 is not directly connected to the first radiator 210 to form a slot or the second radiator 220 is not directly connected to the ground plane 300 to form a slot. In this embodiment of this application, being spaced may be correspondingly understood. The second radiator 220 is coupled to the first radiator 210 by using the slot.

A ratio of a size L2 of the second radiator 220 in the second direction to a size L3 of the second radiator 220 in the first direction is greater than 1. The second radiator may be sheet-shaped. The second direction is perpendicular to the first direction, and may be the extension direction of the first radiator 210 (for example, the second direction is the x direction).

A first end and a second end of the first radiator 210 are ground ends, and may form a structure similar to a slot antenna.

As shown in FIG. 5, a first end of the second radiator 220 is an open end, and a second end of the second radiator 220 is a ground end, to form a structure similar to a planar inverted-F antenna. A distance between the first end of the second radiator 220 and the first radiator 210 is less than a distance between the second end of the second radiator 220 and the first radiator 210.

It should be understood that the second end of the second radiator 220 being the ground end may be understood as that the second end of the second radiator 220 is at least partially coupled to the ground plane 300. This is not limited in this embodiment of this application. In an embodiment, the antenna 200 may further include a metal spring plate. A first end of the spring plate is coupled to the ground plane 300, and a second end of the spring plate is coupled to the second end of the second radiator 220 to implement grounding. In an embodiment, a part of the second end of the second radiator 220 may be in coupling connection to the ground plane 300. For example, an edge between the second end and the first end of the second radiator 220 may also be partially grounded. In an embodiment, the second end of the second radiator 220 may be entirely in coupling connection to the ground plane 300.

In an embodiment, the second radiator 220 is sheet-shaped. In the first direction, the first end of the second radiator 220 is a first side close to the first radiator 210, and the second end of the second radiator 220 is a second side away from the first radiator 210. The first side is suspended (open) and is not in coupling connection to the ground plane 300. At least a part of the second side is in coupling connection to the ground plane 300.

An edge of the second radiator 220 may be a straight line, a curve, or a broken line. This is not limited in this embodiment of this application. For brevity of description, description is provided by merely using an example in which the edge is a straight line.

A distance D1 between the first radiator 210 and the second radiator 220 is less than or equal to 10 mm, so that a relatively good coupling characteristic is implemented between the first radiator 210 and the second radiator 220. In this case, a resonance can be generated at the same time. In an embodiment, the distance D1 between the first radiator 210 and the second radiator 220 is less than or equal to 5 mm.

It should be understood that the distance D1 between the first radiator 210 and the second radiator 220 may be understood as a minimum value of a distance between a point on the first radiator 210 and a point on the second radiator 220.

In an embodiment, the first radiator 210 and the second radiator 220 may be configured to generate a first resonance. The distance D1 between the first radiator 210 and the second radiator 220 is less than or equal to a quarter of a first wavelength. The first wavelength is a wavelength corresponding to the first resonance.

It should be understood that because the coupling characteristic between the first radiator 210 and the second radiator 220 is related to a frequency, the distance between the first radiator 210 and the second radiator 220 may also be determined based on an actual operating frequency band of the antenna 200. A higher frequency of the operating frequency band indicates a shorter distance, and a lower frequency of the operating frequency band indicates a longer distance. In addition, the first wavelength being the wavelength corresponding to the first resonance may be understood as a vacuum wavelength corresponding to a resonance point frequency of the first resonance, or a vacuum wavelength corresponding to a center frequency of a resonance frequency band. Because a correspondence exists between a vacuum wavelength and a dielectric wavelength (operating wavelength), the dielectric wavelength (operating wavelength) may be determined based on the vacuum wavelength.

According to the technical solutions provided in this embodiment of this application, a new antenna structure is formed by using the first radiator 210 and the second radiator 220 that are disposed close to each other (for example, the distance D1 is less than or equal to 10 mm or a quarter of the first wavelength). The first radiator 210 and the second radiator 220 are configured to generate a composite antenna mode (generated by the first radiator and the second radiator together, and not generated by a single radiator), and have relatively low directivity factors, so that the electronic device 10 has good communication performance in all directions.

In an embodiment, the resonance point frequency of the first resonance is greater than or equal to 0.7 GHZ and less than or equal to 6 GHz.

In an embodiment, the first radiator 210 and the second radiator 220 may be configured to generate the first resonance. At the resonance point of the first resonance, a direction of an electric field between the first radiator 210 and the second radiator 220 is opposite to that of an electric field between the first radiator 210 and the ground plane 300.

It should be understood that, because the first radiator 210 may form a structure similar to a slot antenna, the second radiator 220 may form a structure similar to a planar inverted-F antenna. A maximum radiation direction of the slot antenna is opposite to a maximum radiation direction of the planar inverted-F antenna (for example, the maximum radiation direction of the slot antenna is a screen direction (for example, a positive direction of a z direction (z>0)), and the maximum radiation direction of the planar inverted-F antenna is a rear cover direction (for example, a negative direction of the z direction (z<0))). However, because both the electric field between the first radiator 210 and the second radiator 220 and the electric field between the first radiator 210 and the ground plane 300 may generate magnetic fields parallel to the ground plane 300 (for example, parallel to an x-y plane), a radiation characteristic of the antenna in a direction parallel to the ground plane 300 (for example, parallel to the x-y plane) is improved. Therefore, the antenna 200 may have a relatively low directivity factor, so that the electronic device 10 has good communication performance in all directions.

In an embodiment, the resonance frequency band of the first resonance may include a first frequency band. In an embodiment, the first frequency band may include a 2.4G frequency band or a 5G frequency band of Wi-Fi. In an embodiment, the 2.4G frequency band may include 2.4 GHz to 2.4835 GHz. In an embodiment, the 5G frequency band may include 5.17 GHz to 5.33 GHZ.

In an embodiment, a ratio of a length of an overlapping part between the first radiator 210 and the second radiator 220 in the first direction (an overlapping part between a projection of the second radiator 220 on the side frame 11 in the first direction and the first radiator 210) to a length of the first radiator 210 is greater than or equal to 30%. In an embodiment, a ratio of a length of an overlapping part between the first radiator 210 and the second radiator 220 in the first direction (an overlapping part between a projection of the second radiator 220 on the side frame 11 in the first direction and the first radiator 210) to a length of the first radiator 210 is greater than or equal to 50%.

In an embodiment, the first radiator 210 and the second radiator 220 fully overlap in the first direction.

It should be understood that, when the ratio is greater than or equal to 30%, a relatively good coupling characteristic may be implemented between the first radiator 210 and the second radiator 220, and the antenna 200 has a better radiation characteristic. When the first radiator 210 and the second radiator 220 fully overlap in the first direction, the coupling characteristic between the first radiator 210 and the second radiator 220 is optimal.

The first location 201 and the second location 202 are respectively on a first side and a second side that intersect at an angle on the side frame. The extension direction of the first radiator 210 includes an extension direction (for example, an x direction) of the first side and an extension direction (for example, a y direction) of the second side. A length of an overlapping part may be understood as a sum of a length of the overlapping part in the extension direction (for example, the x direction) of the first side and a length of the overlapping part in the extension direction (for example, the y direction) of the second side.

In an embodiment, a length L1 of the first radiator 210 and a size L2 of the second radiator in the second direction (for example, the x direction) satisfy L1×50%≤L2≤L1×200%.

It should be understood that, when the length L1 of the first radiator 210 and the size L2 of the second radiator 220 in the second direction are within the foregoing range, this helps generate the composite mode of the first radiator 210 and the second radiator 220, thereby improving a radiation characteristic of the antenna 200 at the first resonance.

In an embodiment, the first radiator 210 may operate in a one-half-wavelength mode. An electrical length of the first radiator 210 may be a half of the first wavelength.

In an embodiment, the second radiator 220 may operate in a one-half-wavelength mode. An electrical length of the second radiator 220 in the first direction is a quarter of the first wavelength.

In an embodiment, when an electrical length of an electronic element coupled to the first radiator 210/the second radiator 220 may be unchanged, and a physical length of the electronic element may be increased or reduced, the length L1 of the first radiator 210 and a size L3 of the second radiator in the first direction (for example, the y direction) satisfy L1×25%≤L3≤L1×75%.

In an embodiment, the size of the second radiator 220 in the first direction may be greater than or equal to 2 mm and less than or equal to 25 mm.

In an embodiment, the size of the second radiator 220 in the first direction may be greater than or equal to one twenty-fifth of the first wavelength and less than or equal to a half of the first wavelength.

It should be understood that the size of the second radiator 220 in the first direction may be used to adjust coupling between the first radiator 210 and the second radiator 220, to adjust the resonance point frequency of the first resonance generated in the composite mode.

In an embodiment, a ratio of the size L2 of the second radiator 220 in the second direction to the size L3 of the second radiator 220 in the first direction is greater than 1 and less than or equal to 3.

It should be understood that the size L2 of the second radiator 220 in the second direction (for example, the x direction) increases, to improve radiation efficiency and system efficiency of the antenna 200.

In addition, the first radiator 210 may be in a structure similar to a slot antenna, and the second radiator 220 may be in a structure similar to a PIFA. This helps generate the composite mode of the first radiator 210 and the second radiator 220.

In an embodiment, the antenna 200 may further include a bracket, and the second radiator 220 may be located on a surface of the bracket. In an embodiment, the second radiator 220 may be located at a surface of the electronic device 10, for example, located at a surface facing the PCB.

In an embodiment, the antenna 200 may further include a feed circuit 230. The second radiator 220 may include a feed point 221. The circuit 230 is in coupling connection to the feed point 221 to feed an electrical signal to the antenna 200.

In an embodiment, the electronic device 10 may be an electronic device having a large display, for example, a tablet computer, a smart screen, or a notebook computer.

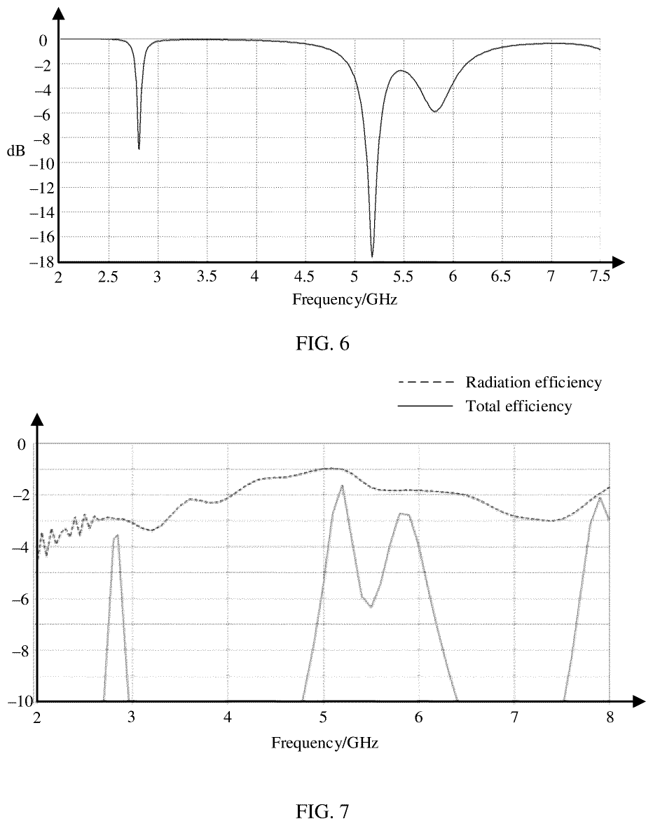

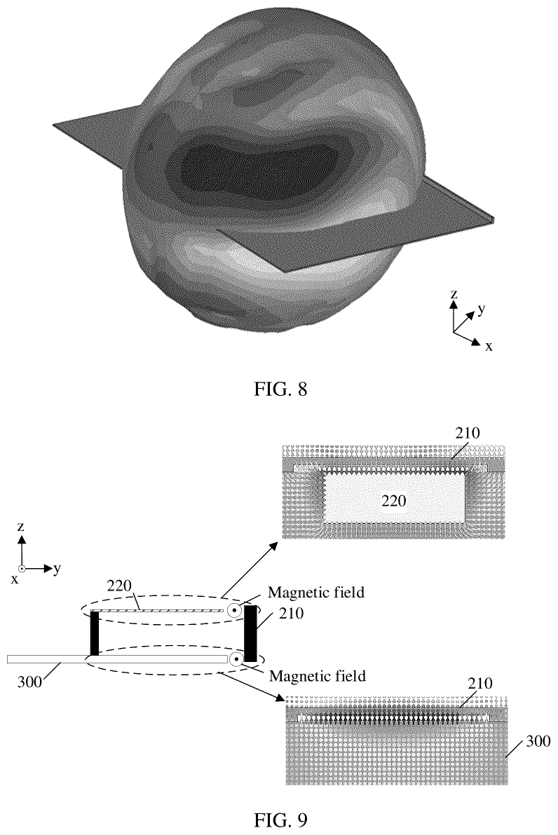

FIG. 6 to FIG. 9 show simulation results of the antenna 200 in the electronic device 10 shown in FIG. 4. FIG. 6 shows an S-parameter simulation result of the antenna 200 shown in FIG. 4. FIG. 7 shows simulation results of radiation efficiency and system efficiency of the antenna 200 shown in FIG. 4. FIG. 8 is a directivity pattern of the antenna 200 shown in FIG. 4 at a resonance point (for example, 5.2 GHZ) of a first resonance. FIG. 9 is a diagram of electric field distribution of the antenna 200 shown in FIG. 4 at a resonance point (for example, 5.2 GHz) of a first resonance.

As shown in FIG. 6, the antenna may generate resonances near 2.8 GHz, near 5.2 GHz, and near 5.8 GHz. The resonance generated near 5.2 GHz is the first resonance in the foregoing embodiment. A resonance frequency band of the first resonance may include a 5G frequency band of Wi-Fi.

As shown in FIG. 7, in a 5G frequency band of Wi-Fi, the antenna has good radiation efficiency and good system efficiency.

As shown in FIG. 8, radiation characteristics of the antenna in all directions are approximately the same, and a directivity factor of the antenna is 3.7 dBi, so that the electronic device can have good communication performance in all directions.

As shown in FIG. 9, at the resonance point of the first resonance, a direction of an electric field between the first radiator 210 and the second radiator 220 is opposite to that of an electric field between the first radiator 210 and the ground plane 300. The electric field between the first radiator 210 and the second radiator 220 is directed from the first radiator 210 to the second radiator 220. For example, the electric field is in a negative direction of a y-axis. The electric field between the first radiator 210 and the ground plane 300 is directed from the ground plane 300 to the first radiator 210. For example, the electric field is in a positive direction of the y-axis.

However, because both the electric field between the first radiator 210 and the second radiator 220 and the electric field between the first radiator 210 and the ground plane 300 may generate magnetic fields parallel to the ground plane 300 (for example, parallel to an x-y plane), for example, directions of the magnetic fields are the same in a positive direction of a z-axis, a radiation characteristic of the antenna in a direction parallel to the ground plane 300 (for example, parallel to the x-y plane) is improved.

In an embodiment, because the magnetic fields parallel to the ground plane 300 (for example, parallel to the x-y plane) may be generated, a null of the directivity pattern is not located in a circumferential direction of the electronic device, thereby improving the radiation characteristic of the antenna in the direction parallel to the ground plane 300 (for example, parallel to the x-y plane). The null of the directivity pattern may be understood as a minimum amplitude of the directivity pattern.

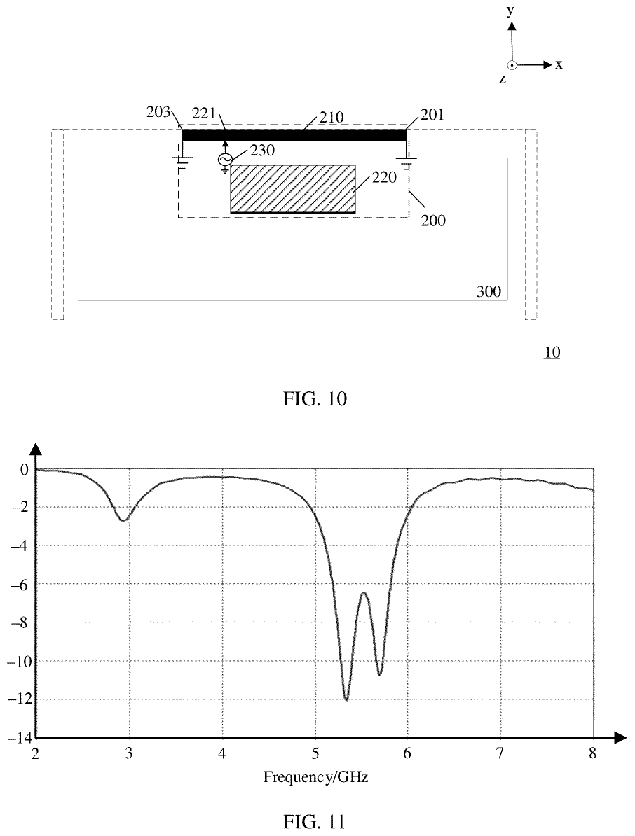

FIG. 10 is a diagram of another electronic device 10 according to an embodiment of this application.

As shown in FIG. 10, a first radiator 210 may include a feed point 221, and a feed circuit 230 is in coupling connection to the feed point 221.

It should be understood that a difference between the antenna 200 shown in FIG. 10 and the antenna 200 shown in FIG. 4 lies merely in a location of the feed point 221. In the antenna 200 shown in FIG. 10, the feed point 221 is located on the first radiator 210. In the antenna 200 shown in FIG. 4, the feed point 221 is located on a second radiator 220. The two different feed points 221 may implement the same technical effect.

For brevity of description, similar parts between the antenna 200 shown in FIG. 10 and the antenna 200 shown in FIG. 4 are not described one by one in detail, for example, a location of the first radiator 210 and a location relationship between the first radiator 210 and the second radiator 220, a proportion relationship between a physical length of the first radiator 210 and a physical length of the second radiator 220, that the first radiator 210 and the second radiator 220 are configured to generate a first resonance, and that at a resonance point of the first resonance, a direction of an electric field between the first radiator 210 and the second radiator 220 is opposite to that of an electric field between the first radiator 210 and the ground plane 300.

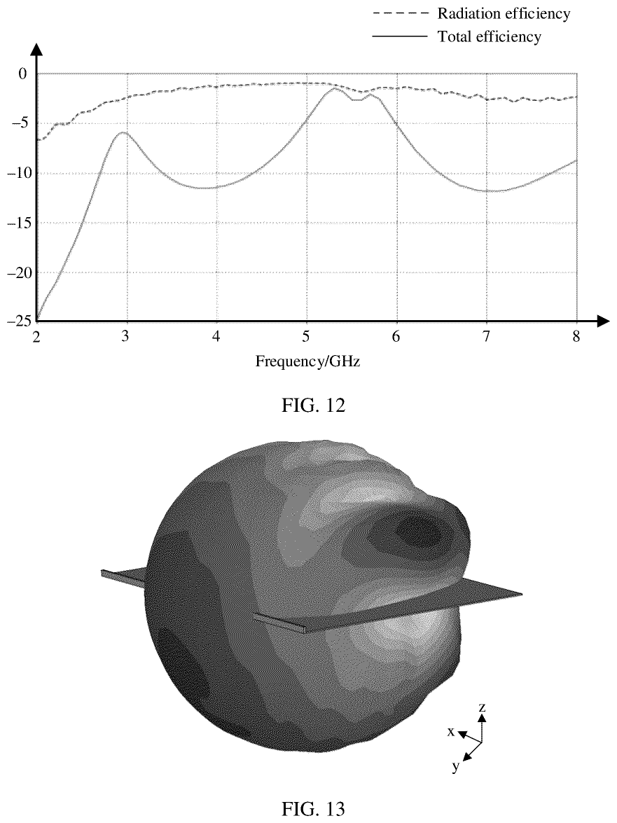

FIG. 11 to FIG. 13 show simulation results of the antenna 200 in the electronic device 10 shown in FIG. 10. FIG. 11 shows an S-parameter simulation result of the antenna 200 shown in FIG. 10. FIG. 12 shows simulation results of radiation efficiency and system efficiency of the antenna 200 shown in FIG. 10. FIG. 13 is a directivity pattern of the antenna 200 shown in FIG. 10 at a resonance point (for example, 5.2 GHz) of a first resonance.

As shown in FIG. 11, the antenna may generate resonances near 2.9 GHz, near 5.2 GHz, and near 5.8 GHz. The resonance generated near 5.2 GHz is the first resonance in the foregoing embodiment. A resonance frequency band of the first resonance may include a 5G frequency band of Wi-Fi.

As shown in FIG. 12, in a 5G frequency band of Wi-Fi, the antenna has good radiation efficiency and good system efficiency.

As shown in FIG. 13, at the resonance point (for example, 5.2 GHZ) of the first resonance, radiation characteristics of the antenna in all directions are approximately the same, and a directivity factor of the antenna is 2.04 dBi, so that the electronic device can have good communication performance in all directions.

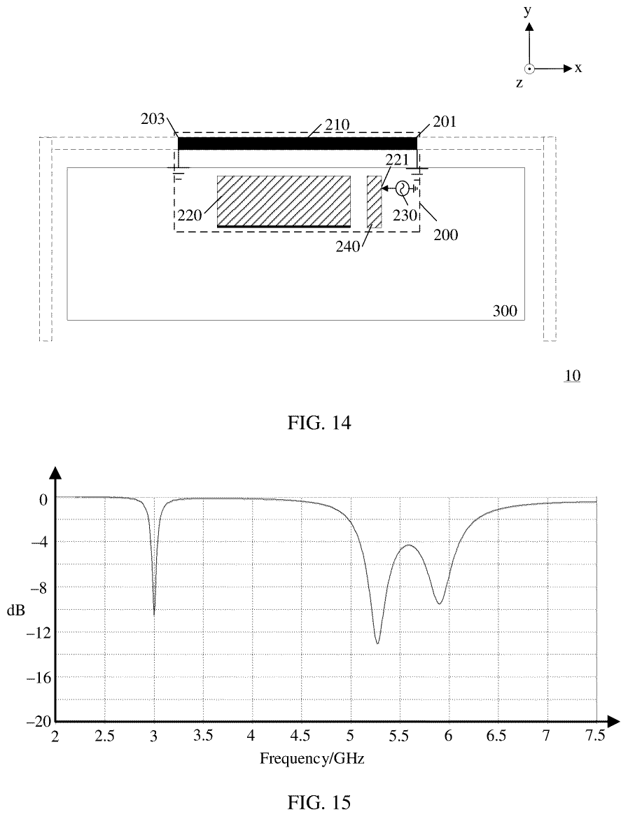

FIG. 14 is a diagram of another electronic device 10 according to an embodiment of this application.

As shown in FIG. 14, an antenna 200 may further include a feed stub 240. The feed stub 240 is spaced from a first radiator 210, a second radiator 220, and a ground plane 300. The feed stub 240 includes a feed point 221, and a feed circuit 230 is coupled to the feed point 221.

In an embodiment, a distance between the first radiator 210 and the feed stub 240 is less than or equal to 5 mm, and/or a distance between the feed stub 240 and the second radiator 220 is less than or equal to 5 mm, so that a relatively good coupling characteristic is implemented between the feed stub 240 and the first radiator 210/the second radiator 220. In this way, the first radiator 210 and the second radiator 220 can be excited to generate a resonance.

It should be understood that the distance between the first radiator 210 or the second radiator 220 and the feed stub 240 may be understood as a minimum value of a distance between a point on the radiator and a point on the feed stub 240.

In an embodiment, a first end and a second end of the feed stub 240 may be open ends. In an embodiment, a first end of the feed stub 240 is a ground end, and a second end of the feed stub 240 may be an open end. In an embodiment, a first end and a second end of the feed stub 240 may be ground ends.

It should be understood that, in this embodiment of this application, the feed stub 240 is electrically connected to the feed circuit 230, and the feed stub 240 generates a resonance with the first radiator 210 and the second radiator 220 in an indirect coupling manner. A boundary condition of the feed stub 240 (whether the feed stub 240 is in coupling connection to the ground plane 300) is not limited in this embodiment of this application, and may be determined based on actual production or design.

In an embodiment, the feed stub 240 may be in a sheet shape, a strip shape, or another shape. This is not limited in this embodiment of this application.

It should be understood that a difference between the antenna 200 shown in FIG. 14 and the antenna 200 shown in FIG. 4 lies merely in a location of the feed point 221. In the antenna 200 shown in FIG. 14, the feed point 221 is located on the feed stub 240. In the antenna 200 shown in FIG. 4, the feed point 221 is located on the second radiator 220. The two different feed points 221 may implement the same technical effect.

For brevity of description, similar parts between the antenna 200 shown in FIG. 14 and the antenna 200 shown in FIG. 4 are not described one by one in detail, for example, a location of the first radiator 210 and a location relationship between the first radiator 210 and the second radiator 220, a proportion relationship between a physical length of the first radiator 210 and a physical length of the second radiator 220, that the first radiator 210 and the second radiator 220 are configured to generate a first resonance, and that at a resonance point of the first resonance, a direction of an electric field between the first radiator 210 and the second radiator 220 is opposite to that of an electric field between the first radiator 210 and the ground plane 300.

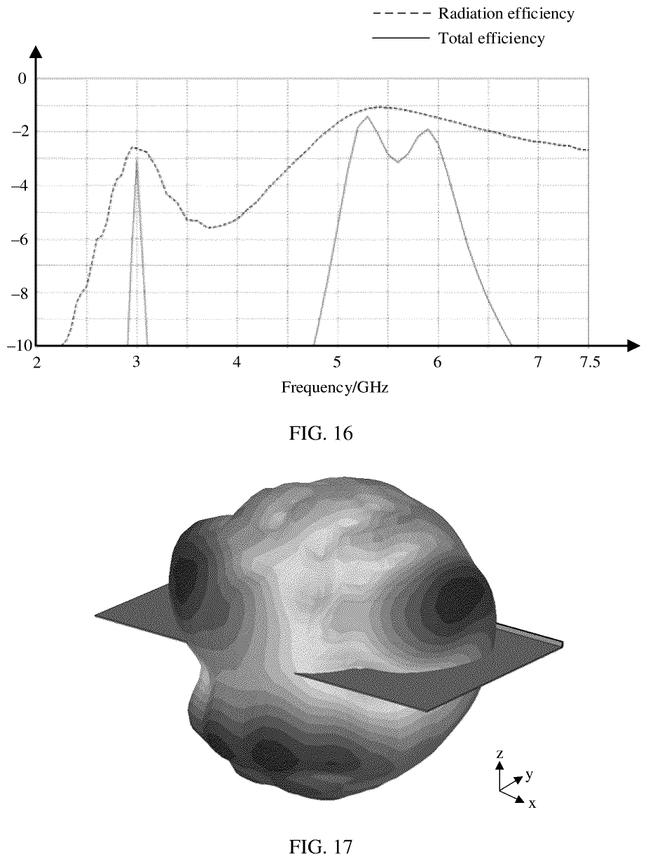

FIG. 15 to FIG. 17 show simulation results of the antenna 200 in the electronic device 10 shown in FIG. 14. FIG. 15 shows an S-parameter simulation result of the antenna 200 shown in FIG. 14. FIG. 16 shows simulation results of radiation efficiency and system efficiency of the antenna 200 shown in FIG. 14. FIG. 17 is a directivity pattern of the antenna 200 shown in FIG. 14 at a resonance point (for example, 5.2 GHz) of a first resonance.

As shown in FIG. 15, the antenna may generate resonances near 3 GHZ, near 5.2 GHz, and near 5.8 GHz. The resonance generated near 5.2 GHz is the first resonance in the foregoing embodiment. A resonance frequency band of the first resonance may include a 5G frequency band of Wi-Fi.

As shown in FIG. 16, in a 5G frequency band of Wi-Fi, the antenna has good radiation efficiency and good system efficiency.

As shown in FIG. 17, at the resonance point (for example, 5.2 GHz) of the first resonance, radiation characteristics of the antenna in all directions are approximately the same, and a directivity factor of the antenna is 2.81 dBi, so that the electronic device can have good communication performance in all directions.

It should be understood that, in the electronic device 10 shown in FIG. 4, FIG. 10, and FIG. 14, the antenna 200 may have approximately the same radiation characteristics in all directions in different feeding manners (in the technical solution shown in FIG. 4, the feed circuit 230 is electrically connected to the second radiator 220; in the technical solution shown in FIG. 10, the feed circuit 230 is electrically connected to the first radiator 210; and in the technical solution shown in FIG. 14, the feed circuit 230 is electrically connected to the feed stub 240). This has a characteristic of a low directivity factor.

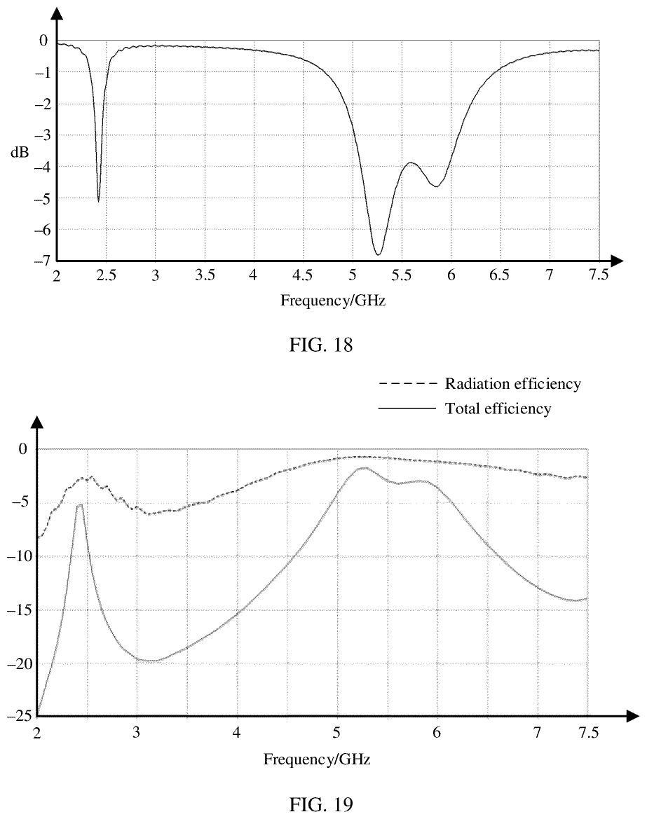

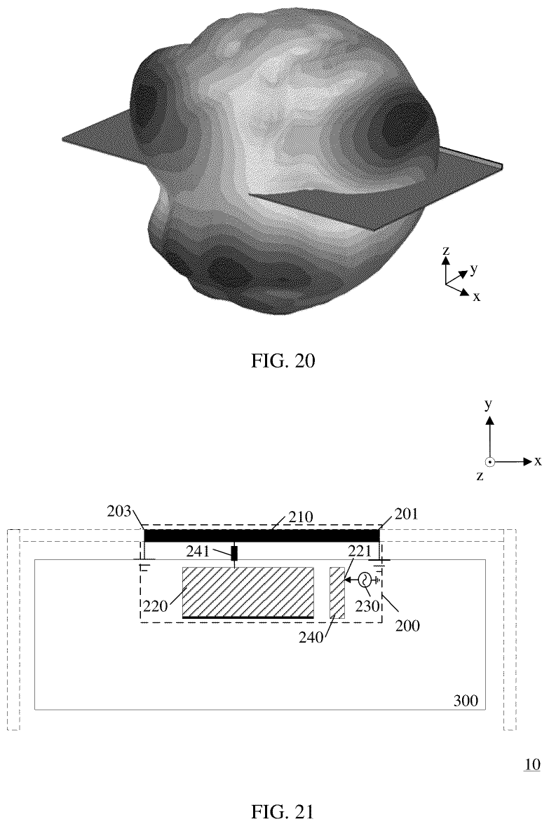

FIG. 18 to FIG. 20 show other simulation results of the antenna 200 in the electronic device 10 shown in FIG. 14. FIG. 18 shows an S-parameter simulation result of the antenna 200 shown in FIG. 14. FIG. 19 shows simulation results of radiation efficiency and system efficiency of the antenna 200 shown in FIG. 14. FIG. 20 is a directivity pattern of the antenna 200 shown in FIG. 14 at a resonance point (for example, 5.2 GHz) of a first resonance.

It should be understood that, in the antenna 200 shown in FIG. 14, the first radiator 210 and the second radiator 220 may be further configured to generate a second resonance (for example, in the foregoing simulation results, the second resonance may be a resonance generated near 3 GHZ). A resonance frequency of the second resonance is lower than a resonance frequency of the first resonance. A resonance frequency band of the second resonance may include a second frequency band.

When an electrical parameter of the antenna 200 (for example, a size of the second radiator 220 in the second direction and a distance between the first radiator 210 and the second radiator 220) changes, a coupling quantity between the first radiator 210 and the second radiator 220 may be controlled, to adjust a resonance frequency of a resonance generated by the antenna 200. In an embodiment, a resonance point frequency of the second resonance may be adjusted by using the foregoing electrical parameters. In an embodiment, the first frequency band may include a 5G frequency band of Wi-Fi, and the second frequency band may include a 2.4G frequency band of Wi-Fi. The antenna 200 may operate on all of different frequency bands of Wi-Fi, to improve communication performance of the electronic device 10.

For brevity of description, the antenna 200 in the electronic device 10 shown in FIG. 14 is used merely as an example for description. Another technical solution provided in this embodiment of this application may also be applied. Details are not described again.

As shown in FIG. 18, the antenna may generate resonances near 2.4 GHz, near 5.2 GHz, and near 5.8 GHz. The resonance generated near 5.2 GHz is the first resonance in the foregoing embodiment. A resonance frequency band of the first resonance may include a 5G frequency band of Wi-Fi. The resonance generated near 2.4 GHz is the second resonance in the foregoing embodiment. A resonance frequency band of the second resonance may include a 2.4G frequency band of Wi-Fi.

As shown in FIG. 19, in a 5G frequency band of Wi-Fi, the antenna has good radiation efficiency and good system efficiency. On the 2.4G frequency band of Wi-Fi, radiation efficiency and system efficiency of the antenna are slightly lower than radiation efficiency and system efficiency of the antenna on the 5G frequency band of Wi-Fi.

As shown in FIG. 20, at the resonance point (for example, 5.2 GHZ) of the first resonance, radiation characteristics of the antenna in all directions are approximately the same, and a directivity factor of the antenna is 2.8 dBi, so that the electronic device can have good communication performance in all directions.

FIG. 21 is a diagram of another electronic device 10 according to an embodiment of this application.

As shown in FIG. 21, an antenna 200 may further include an electronic element 241. The electronic element 241 is in coupling connection between a first radiator 210 and a second radiator 220.

It should be understood that the electronic element 241 may be configured to control a coupling quantity between the first radiator 210 and the second radiator 220, to adjust a resonance frequency of a resonance generated by the antenna 200. In an embodiment, the electronic element 241 may adjust a resonance point frequency of a second resonance. In an embodiment, a first frequency band may include a 5G frequency band of Wi-Fi, and a second frequency band may include a 2.4G frequency band of Wi-Fi. The antenna 200 may operate on all of different frequency bands of Wi-Fi, to improve communication performance of the electronic device 10.

For brevity of description, the antenna 200 shown in FIG. 14 is merely used as an example for description. The technical solution shown in FIG. 21 may also be applied to the antenna 200 shown in FIG. 4 and the antenna 200 shown in FIG. 10.

In addition, a difference between the antenna 200 shown in FIG. 21 and the antenna 200 shown in FIG. 14 merely lies in the electronic element 241. Similar parts between the antenna 200 shown in FIG. 21 and the antenna 200 shown in FIG. 14 are not described one by one in detail, for example, a location of the first radiator 210 and a location relationship between the first radiator 210 and the second radiator 220, a proportion relationship between a physical length of the first radiator 210 and a physical length of the second radiator 220, that the first radiator 210 and the second radiator 220 are configured to generate a first resonance, and that at a resonance point of the first resonance, a direction of an electric field between the first radiator 210 and the second radiator 220 is opposite to that of an electric field between the first radiator 210 and the ground plane 300.

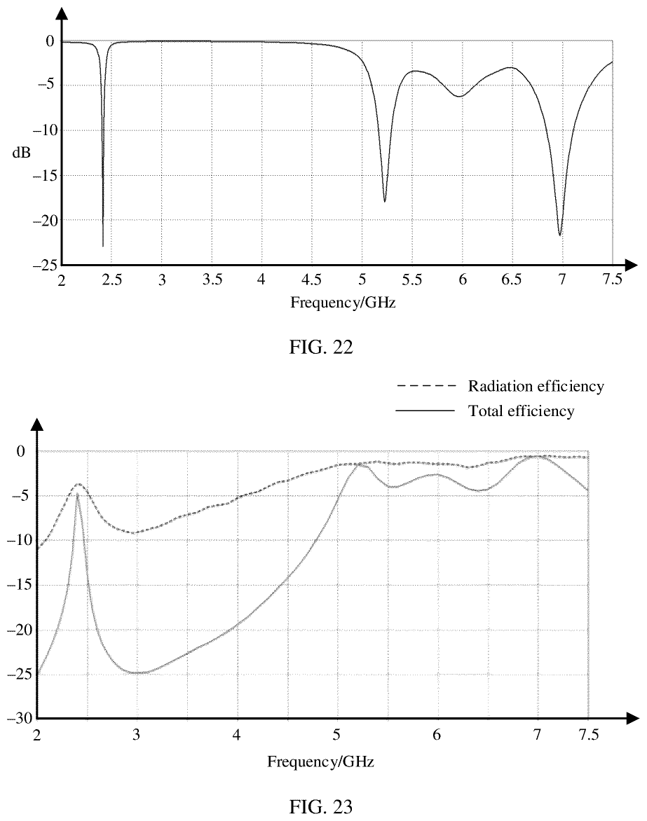

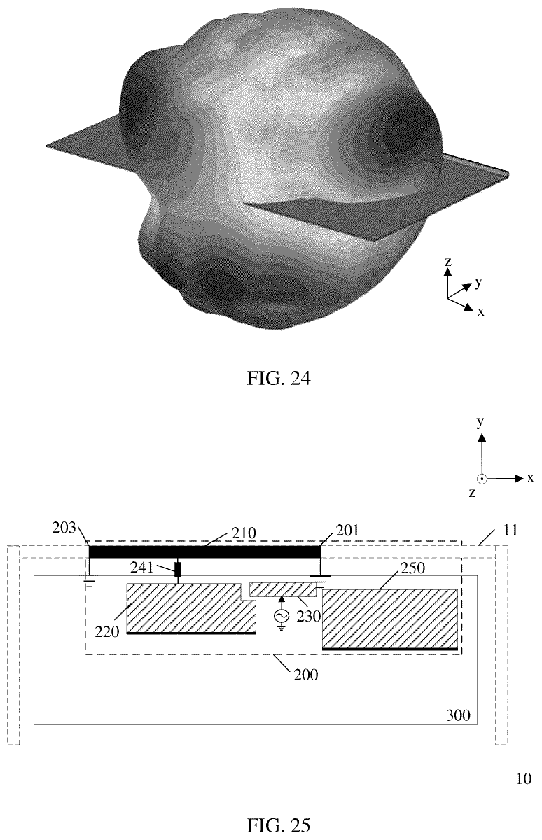

FIG. 22 to FIG. 24 show simulation results of the antenna 200 in the electronic device 10 shown in FIG. 21. FIG. 22 shows an S-parameter simulation result of the antenna 200 shown in FIG. 21. FIG. 23 shows simulation results of radiation efficiency and system efficiency of the antenna 200 shown in FIG. 21. FIG. 24 is a directivity pattern of the antenna 200 shown in FIG. 21 at a resonance point (for example, 5.2 GHz) of a first resonance.

As shown in FIG. 22, the antenna may generate resonances near 2.4 GHz, near 5.2 GHz, near 6 GHz, and near 7 GHz. The resonance generated near 5.2 GHz is the first resonance in the foregoing embodiment. A resonance frequency band of the first resonance may include a 5G frequency band of Wi-Fi. The resonance generated near 2.4 GHz is the second resonance in the foregoing embodiment. A resonance frequency band of the second resonance may include a 2.4G frequency band of Wi-Fi.

As shown in FIG. 23, in a 5G frequency band of Wi-Fi, the antenna has good radiation efficiency and good system efficiency. On the 2.4G frequency band of Wi-Fi, radiation efficiency and system efficiency of the antenna are slightly lower than radiation efficiency and system efficiency of the antenna on the 5G frequency band of Wi-Fi.

As shown in FIG. 24, at the resonance point (for example, 5.2 GHz) of the first resonance, radiation characteristics of the antenna in all directions are approximately the same, and a directivity factor of the antenna is 2.81 dBi, so that the electronic device can have good communication performance in all directions.

FIG. 25 is a diagram of another electronic device 10 according to an embodiment of this application.

As shown in FIG. 25, an antenna 200 may further include a parasitic stub 250. A feed stub 240 is located between a second radiator 220 and the parasitic stub 250. The parasitic stub 250 is spaced from the feed stub 240 and the ground plane 300.

A ratio of a size of the parasitic stub 250 in a second direction (for example, an x direction) to a size of the parasitic stub 250 in a first direction (for example, a y direction) is greater than 1. The parasitic stub 250 may be sheet-shaped.

A first end of the parasitic stub 250 is an open end, and a second end of the parasitic stub 250 is a ground end, to form a structure similar to a planar inverted-F antenna. In an embodiment, a distance between the first end of the parasitic stub 250 and a side frame 11 is less than a distance between the second end of the parasitic stub 250 and the side frame 11. An end that is of the parasitic stub 250 and that is close to the side frame 11 may be an open end, and an end that is of the parasitic stub 250 and that is away from the side frame 11 may be a ground end.

It should be understood that when the feed circuit 230 feeds an electrical signal, the parasitic stub 250 may generate a parasitic resonance. A resonance frequency band of the parasitic resonance may include a third frequency band. The antenna 200 may extend an operating bandwidth by using the parasitic resonance.

Efficiency (for example, radiation efficiency and system efficiency) of the parasitic resonance generated by the parasitic stub 250 is higher than efficiency at the second resonance generated by the first radiator 210 and the second radiator 220. Compared with the second resonance, a radiation characteristic of the antenna on the frequency band can be improved by using the resonance frequency band of the parasitic resonance as a communication frequency band.

In an embodiment, a ratio of a size of the parasitic stub 250 in the second direction to a size of the parasitic stub 250 in the first direction is greater than 1 and less than or equal to 3.

In an embodiment, a distance between the parasitic stub 250 and at least one of the feed stub 240, the first radiator 210, and the second radiator 220 is less than or equal to 5 mm.

It should be understood that for brevity of description, the antenna 200 shown in FIG. 14 is merely used as an example for description. The technical solution shown in FIG. 25 may also be applied to the antenna 200 shown in FIG. 4 and the antenna 200 shown in FIG. 10.

In addition, a difference between the antenna 200 shown in FIG. 25 and the antenna 200 shown in FIG. 14 merely lies in the parasitic stub 250. Similar parts between the antenna 200 shown in FIG. 25 and the antenna 200 shown in FIG. 14 are not described one by one in detail, for example, a location of the first radiator 210 and a location relationship between the first radiator 210 and the second radiator 220, a proportion relationship between a physical length of the first radiator 210 and a physical length of the second radiator 220, that the first radiator 210 and the second radiator 220 are configured to generate a first resonance, and that at a resonance point of the first resonance, a direction of an electric field between the first radiator 210 and the second radiator 220 is opposite to that of an electric field between the first radiator 210 and the ground plane 300.

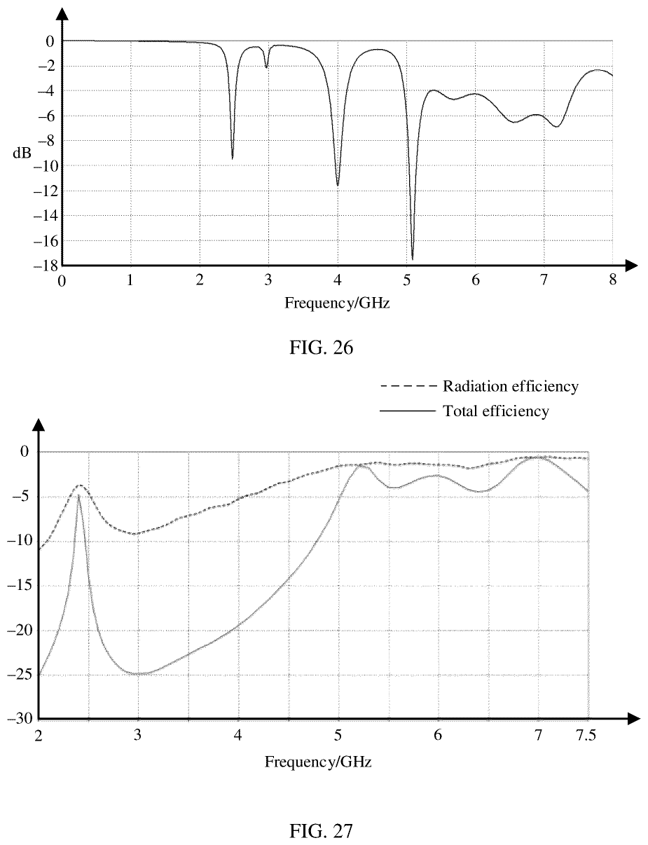

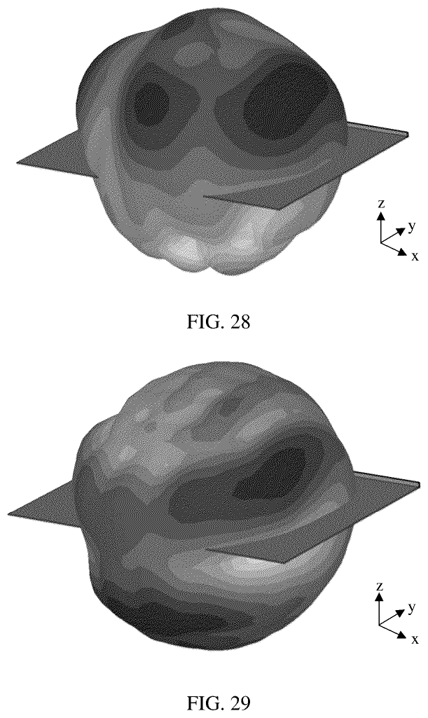

FIG. 26 to FIG. 29 show simulation results of the antenna 200 in the electronic device 10 shown in FIG. 25. FIG. 26 shows an S-parameter simulation result of the antenna 200 shown in FIG. 25. FIG. 27 shows simulation results of radiation efficiency and system efficiency of the antenna 200 shown in FIG. 25. FIG. 28 is a directivity pattern of the antenna 200 shown in FIG. 25 at a resonance point (for example, 2.4 GHz) of a parasitic resonance. FIG. 29 is a directivity pattern of the antenna 200 shown in FIG. 25 at a resonance point (for example, 5.2 GHz) of a first resonance.

As shown in FIG. 26, the antenna may generate resonances near 2.4 GHz, near 3 GHz, near 4 GHz, near 5.2 GHz, near 5.8 GHz, near 6.5 GHZ, and near 7.2 GHz. The resonance generated near 5.2 GHz is the first resonance in the foregoing embodiment. A resonance frequency band of the first resonance may include a 5G frequency band of Wi-Fi. The resonance generated near 3 GHz is the second resonance in the foregoing embodiment. The resonance generated near 2.4 GHz is the parasitic resonance in the foregoing embodiment. A resonance frequency band of the parasitic resonance may include a 2.4G frequency band of Wi-Fi.

As shown in FIG. 27, in a 5G frequency band of Wi-Fi, the antenna has good radiation efficiency and good system efficiency. In a 2.4G frequency band of Wi-Fi, the antenna has good radiation efficiency and good system efficiency.

As shown in FIG. 28, at the resonance point (for example, 2.4 GHz) of the parasitic resonance, radiation characteristics of the antenna in all directions are approximately the same, and a directivity factor of the antenna is 4.21 dBi, so that the electronic device can have good communication performance in all directions.

As shown in FIG. 29, at the resonance point (for example, 5.2 GHZ) of the first resonance, radiation characteristics of the antenna in all directions are approximately the same, and a directivity factor of the antenna is 3.89 dBi, so that the electronic device can have good communication performance in all directions.

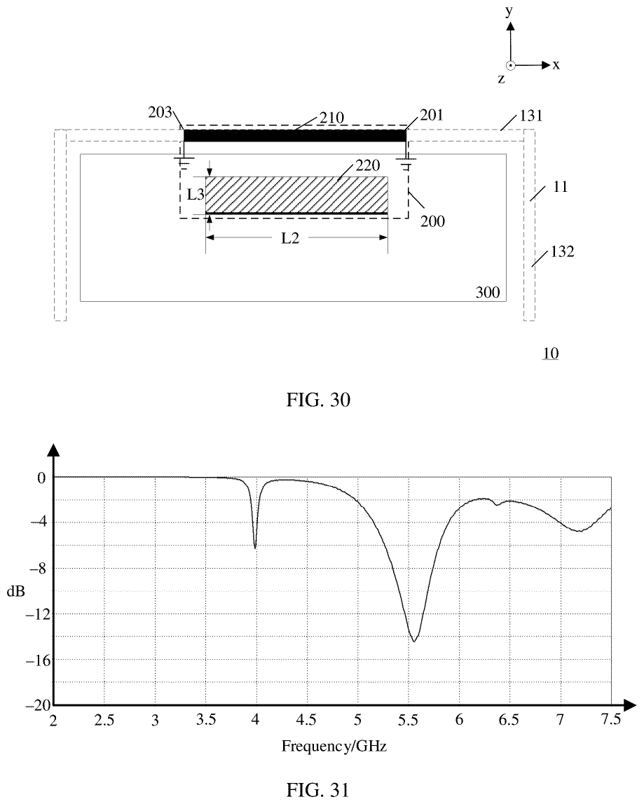

FIG. 30 is a diagram of another electronic device 10 according to an embodiment of this application.

As shown in FIG. 30, a ratio of a size L2 of a second radiator 220 in a second direction to a size L3 of the second radiator 220 in a first direction is greater than 3.

In an embodiment, a ratio of the size L2 of the second radiator 220 in the second direction to the size L3 of the second radiator 220 in the first direction is greater than or equal to 6.

It should be understood that, as the ratio of the size L2 of the second radiator 220 in the second direction to the size L3 of the second radiator 220 in the first direction increases (for example, the size L2 of the second radiator 220 in the second direction is reduced, and/or the size L3 of the second radiator 220 in the first direction is increased), bandwidth (for example, S11<−4 dB is used as a boundary) of the antenna 200 on a resonance frequency band of a first resonance increases, and the electronic device 10 can operate on more frequency bands.

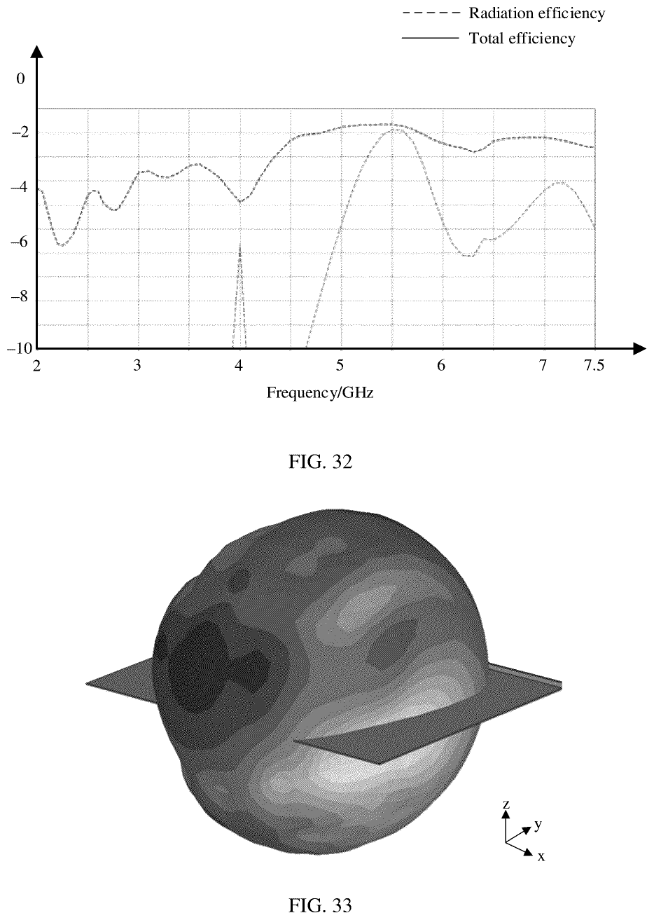

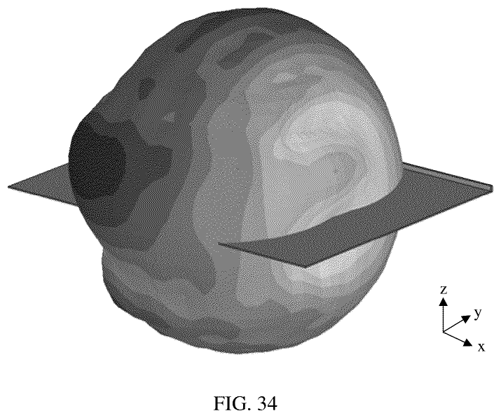

FIG. 31 to FIG. 34 show simulation results of an antenna 200 in the electronic device 10 shown in FIG. 30. FIG. 31 shows an S-parameter simulation result of an antenna 200 shown in FIG. 30. FIG. 32 shows simulation results of radiation efficiency and system efficiency of an antenna 200 shown in FIG. 30. FIG. 33 is a directivity pattern of an antenna 200 shown in FIG. 30 at 5.2 GHz. FIG. 34 is a directivity pattern of an antenna 200 shown in FIG. 30 at 5.8 GHz.

As shown in FIG. 31, the antenna may generate resonances near 4 GHZ, near 5.5 GHz, near 6.4 GHz, and near 7.2 GHz. The resonance generated near 5.5 GHz is the first resonance in the foregoing embodiment. A resonance frequency band of the first resonance may include a 5G frequency band of Wi-Fi.

With S11<−2 dB as a boundary, a resonance frequency band of the antenna may include 5 GHz to 7.5 GHZ, and has a relatively wide resonance frequency band.

As shown in FIG. 32, in a frequency band from 5 GHz to 7.5 GHZ, the antenna has good radiation efficiency and good system efficiency.

As shown in FIG. 33 and FIG. 24, at 5.2 GHz and 5.8 GHZ, radiation characteristics of the antenna in all directions are approximately the same, and directivity factors of the antenna are respectively 3.67 dBi and 4.11 dBi, so that the electronic device can have good communication performance in all directions.

It should be understood that the technical solutions provided in embodiments of this application may be applied to an electronic device with an all-metal ID (metal such as a metal component, a display, a side frame, and a rear cover is disposed around the antenna 200). In an embodiment, the metal disposed around the antenna 200 at least partially overlaps the first radiator or the second radiator in a first direction, a second direction, or a third direction (a direction perpendicular to a second radiator). In the all-metal ID, the antenna 200 may have a good radiation characteristic by using an assembly slot between a mechanical part (or an electronic part) and a mechanical part (or an electronic part) or an insulation slot on a mechanical part (or an electronic part), and is less affected by surrounding metal, to avoid a slot of a conductive (for example, metal) appearance surface of the electronic device, thereby improving appearance integrity and aesthetics of the electronic device.

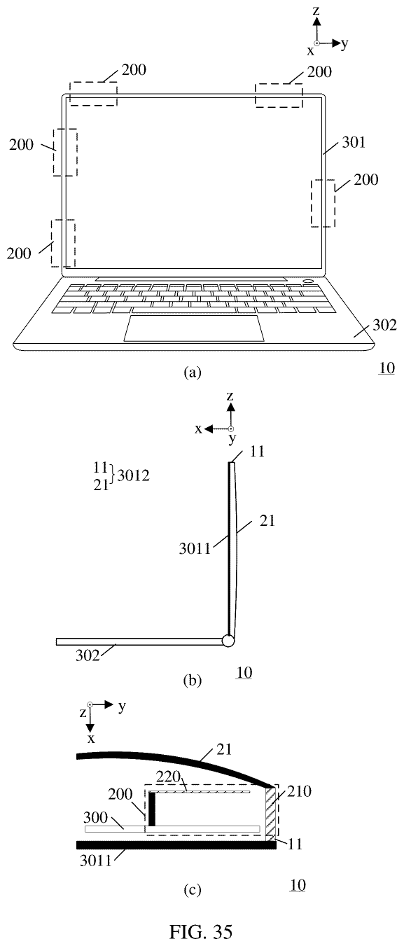

FIG. 35 is a diagram of an electronic device 10 according to an embodiment of this application.

As shown in (a) in FIG. 35, the electronic device 10 may be a personal computer (personal computer, PC). The PC 10 may include a display part 301 and a keyboard part 302. It should be understood that the display part 301 and the keyboard part 302 are rotatably connected, and the display part 301 and the keyboard part 302 may rotate along a connection part, so that the display part 301 and the keyboard part 302 are at different angles. In an embodiment, the display part 301 and the keyboard part 302 may be disassembled or assembled.

As shown in (b) in FIG. 35, the display part 301 may include a display module 3011 and a housing 3012.

The display module 3011 may include a display area and a fixed area. The fixed area may be located in a circumferential direction of the display area, and the fixed area may be configured to connect to the housing 3012. In an embodiment, the display module 3011 may include only a display area.

The housing 3012 may include the side frame 11 and the rear cover 21 connected to the side frame 11 in the foregoing embodiment. The side frame 11 may be made of a conductive material such as metal. The side frame 11 may circumferentially extend around a periphery of the electronic device 10. The side frame 11 may have four sides surrounding the display module 3011, to help fasten the display module 3011.

In an embodiment, a slot is formed between the side frame 11 and the four sides of the display module 3011. The slot may be filled with adhesive, so that the side frame 11 is fastened to the display module 3011. In addition, the slot may further help improve radiation performance of an antenna.

In an embodiment, the side frame 11 and the rear cover 21 may be an integrated structure, and are made of an all-metal material. In an embodiment, the side frame 11 may be made of a metal material, and the rear cover 21 may be made of a non-metal material.

As shown in (a) in FIG. 35, the antenna 200 provided in this embodiment of this application may be located in the display part 301.

As shown in (c) in FIG. 35, a first radiator 210 in the antenna 200 may be a part of the side frame 11, and a second radiator 210 in the antenna 200 may be located between the rear cover 21 and the display module 3011. In an embodiment, the first radiator 210 and the second radiator 220 may be located between the fixed area of the display module 3011 and the rear cover 21.

It should be understood that, in the foregoing embodiment, for brevity of description, the electronic device 10 being a mobile phone is used as an example merely for description. In actual production or design, the electronic device 10 may alternatively be another type of electronic device 10, for example, a smart screen.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An electronic device, comprising:
a ground plane;
a side frame, wherein at least a part of the side frame is spaced from the ground plane, the side frame comprises a first location and a second location, and the side frame is coupled to the ground plane at the first location and the second location; and
an antenna, comprising:
a first radiator comprised of a conductive part of the side frame between the first location and the second location; and
a second radiator spaced from the first radiator and the ground plane, wherein a projection of the second radiator on the side frame in a first direction Y at least partially overlaps the first radiator, the first direction Y perpendicular to an extension direction of the first radiator,
wherein:
the first radiator and the second radiator are configured to generate a first resonance, a distance D1 between the first radiator and the second radiator is less than or equal to 10 mm or a quarter of a first wavelength, and the first wavelength is a wavelength corresponding to the first resonance,
a ratio of a size L2 of the second radiator in a second direction X to a size L3 of the second radiator in the first direction Y is greater than 1, and the second direction X is the extension direction of the first radiator, and
a first end of the second radiator is an open end, a second end of the second radiator is a ground end, and a distance between the first end of the second radiator and the first radiator is less than a distance between the second end of the second radiator and the first radiator.

2. The electronic device according to claim 1, wherein
a length L1 of the first radiator and the size L2 of the second radiator in the second direction X satisfy: L1×50%≤L2≤L1×200%.

3. The electronic device according to claim 1, wherein
a ratio of the size L2 of the second radiator in the second direction X to the size L3 of the second radiator in the first direction Y is less than or equal to 3.

4. The electronic device according to claim 1, wherein
the size L2 of the second radiator in the first direction Y is greater than or equal to one twenty-fifth of the first wavelength and less than or equal to a half of the first wavelength.

5. The electronic device according to claim 1, wherein
a resonance point frequency of the first resonance is greater than or equal to 0.7 GHZ and less than or equal to 6 GHz.

6. The electronic device according to claim 5, wherein
the size L2 of the second radiator in the first direction Y is greater than or equal to 2 mm and less than or equal to 25 mm.

7. The electronic device according to claim 1, wherein
the antenna further comprises an electronic element, wherein the electronic element is in coupling connection between the first radiator and the second radiator.

8. The electronic device according to claim 1, wherein
a ratio of a length of the partial overlap of the projection of the second radiator on the side frame in the first direction Y and the first radiator to the length of the first radiator is greater than or equal to 30%.

9. The electronic device according to claim 1, wherein
the second radiator is sheet-shaped;
in the first direction Y, the first end of the second radiator is a first side close to the first radiator, and the second end of the second radiator is a second side away from the first radiator;
the first side is suspended; and
at least a part of the second side is in coupling connection to the ground plane.

10. The electronic device according to claim 1, wherein
the antenna further comprises a feed circuit, one of the first radiator and the second radiator comprises a feed point, and the feed circuit is coupled to the feed point.

11. The electronic device according to claim 1, wherein
the antenna further comprises a feed circuit and a feed stub; and
the feed stub is spaced from the first radiator, the second radiator, and the ground plane, the feed stub comprises a feed point, and the feed circuit is coupled to the feed point.

12. The electronic device according to claim 11, wherein
the antenna further comprises a parasitic stub, and the feed stub is located between the parasitic stub and the second radiator;
a first end of the parasitic stub is a ground end, and a second end of the parasitic stub is an open end; and
a ratio of a size of the parasitic stub in the first direction Y to a size of the parasitic stub in the second direction X is greater than 1.

13. The electronic device according to claim 12, wherein
the parasitic stub is configured to generate a parasitic resonance, a resonance frequency of the parasitic resonance is lower than a resonance frequency of the first resonance, a resonance frequency band of the first resonance comprises a first frequency band, and a resonance frequency band of the parasitic resonance comprises a third frequency band.

14. The electronic device according to claim 13, wherein
the resonance frequency band of the first resonance comprises the first frequency band, the first frequency band comprises a 5G frequency band of Wi-Fi, and the third frequency band comprises a 2.4G frequency band of Wi-Fi.

15. The electronic device according to claim 1, wherein
the first radiator and the second radiator are further configured to generate a second resonance, a resonance frequency of the second resonance is lower than a resonance frequency of the first resonance, a resonance frequency band of the first resonance comprises a first frequency band, and a resonance frequency band of the second resonance comprises a second frequency band.

16. The electronic device according to claim 15, wherein the first frequency band comprises a 5G frequency band of Wi-Fi, and the second frequency band comprises a 2.4G frequency band of Wi-Fi.

17. The electronic device according to claim 1, wherein
at a resonance point of the first resonance, a direction of an electric field between the first radiator and the second radiator is opposite to that of an electric field between the first radiator and the ground plane.

18. The electronic device according to claim 1, wherein
at a resonance point of the first resonance, a magnetic field between the first radiator and the second radiator and a magnetic field between the first radiator and the ground plane are parallel to the ground plane.
